(19) United States
(12) Patent Application Publication
(10) Pub. No.: US 2011/0275302 A1
(43) Pub. Date: Nov. 10, 2011

(54) IMPROVED TUNNEL VENTILATION DEVICE

(75) Inventor: Fathi Tarada, West Sussex (GB)

(73) Assignee: MOSEN LIMITED, West Sussex (GB)

(21) Appl. No.: 13/125,616

(22) PCT Filed: Oct. 23, 2009
(86) PCT No.: PCT/GB2009/002544

§ 371 Date: Jul. 13, 2011

(30) Foreign Application Priority Data
Oct. 24, 2008 (GB) 0819608.1
Nov. 20, 2008 (GB) 0821278.9
Feb. 9, 2009 (GB) 0902131.2

(51) Int. Cl. E21F 1/00; B05B 1/00

(52) U.S. Cl. 454/166; 222/566

(57) ABSTRACT

A ventilation device that enhances the longitudinal thrust of a fan (2) installed within a tunnel, by the introduction of a convergent nozzle (7) to accelerate the outlet flow (8). An angled transition piece (6) can turn the flow by a specific angle (36). Multiple fans can be connected to common inlet and outlet plenums, supplying one or more convergent nozzles. Bi-directional flow can be achieved by fitting convergent nozzles to both sides of a fan, with bypass dampers optionally installed between the fan and the two nozzles. The nozzle trailing edge can be shaped with multiple lobes, chevrons or tongues, and the fan centre-body can be shaped with multiple lobes. A fire suppression agent such as water mist can be supplied into the ductwork between the fan and the nozzle trailing edge. Acoustic silencing can be achieved using the absorbent material on the nozzle and fan centre-body.

### BACKGROUND OF THE INVENTION

This invention relates to an improved tunnel ventilation device. Tunnels may require ventilation for a variety of reasons—for example to ensure an adequate air quality, to control the spread of smoke in case of fire, or to reduce temperatures to acceptable limits. The function of the ventilation relates to the type of tunnel in question—vehicular tunnels (road, rail and metro) generally require high air quality during normal operation and smoke control in case of fire, while cable tunnels require cooling, smoke control and a certain amount of air exchange. Mine tunnels and station tunnels also require adequate ventilation for physiological, cooling and smoke control requirements. A number of alternative ventilation systems are available for designers to achieve these requirements. For short and medium-length road tunnels (depending on the relevant national guidance, up to approximately 3 km in length for tunnels with unidirectional traffic), longitudinal ventilation systems are normally found to provide the most cost-effective solution. In the simplest version of a longitudinal ventilation system which is employed in some railway tunnels, a mid-tunnel ventilation shaft is used to supply or extract air, which causes a longitudinal flow of air to be generated along the tunnel. More typically, longitudinal ventilation systems comprise jetfans or impulse nozzles to push the tunnel airflow in the desired direction.

Impulse nozzles introduce an air jet into a tunnel, at a high velocity of around 30 m/s. This air jet imparts most of its momentum to the tunnel air, and hence helps to drive the tunnel air in the desired direction. A fraction of the air jet's momentum is lost due to frictional drag on tunnel surfaces, and due to form drag on any bluff bodies that the jet impinges upon. Marco Saccardo patented an ‘Improved Method and Apparatus for Ventilating Tunnels’ in UK patent number 2026, dated 1898. This original patent described the use of air jets to ventilate railway tunnels.

Conventional impulse nozzles supply air into a tunnel, using air generated by fans within a fan chamber. This fan chamber is conventionally constructed above a tunnel portal or shaft, where the air is drawn from outside, and then supplied into the tunnel at a shallow angle to the tunnel longitudinal axis (typically, at an angle of 30 degrees or less). A shallow angle is normally selected, in order to align the jet with the tunnel axis and hence maximise the potential thrust that can be generated; to avoid high-velocity jets inconveniencing or endangering tunnel users and to minimise the frictional losses due to the jet flowing along the floor of the tunnel.

The thrust imparted by air jets flowing from an impulse nozzle to the tunnel air can be described through the following momentum exchange equation:

T=\dot{m}Vⱼηⱼ cos(θ) (Equation 1)

where
T=Thrust imparted from the air jet to the tunnel air [Newtons]
\dot{m}=Mass flow of air jet [kilograms per second]
Vⱼ=Velocity of air jet [metres per second]
ηⱼ=Installation efficiency [dimensionless]
θ=Angle between the jet and the tunnel axis [radians]
In the above equation, the installation efficiency ηⱼ can either reduce (ηⱼ<1) or increase (ηⱼ>1) the thrust, depending on a function of a number of aerodynamic parameters. Irreversible processes such as friction of the jet along the tunnel soffit or floor will cause a reduction in the installation efficiency, typically to a value below unity. However, it has been reported by M. Tabarra et al in “The revival of Saccardo ejectors—history, fundamentals, and applications” (10^{th} International Symposium on Aerodynamics and Ventilation of Vehicle Tunnels, Boston, USA, 1-3 Nov. 2000) that a non-uniform tunnel velocity profile can lead to a value of installation efficiency (called ‘momentum exchange coefficient’ in the above-said paper) above unity.

Compared to jetfans, impulse nozzles have the advantages that no space is required for ventilation equipment within the tunnels; simpler maintenance regimes are required, since no access to the tunnels is necessary to undertake maintenance on the ventilation system; there is significantly less risk of fan damage in case of fire within the tunnel; a reduced noise level in the tunnel is present; and generally a reduced number of fans is required compared with the jetfan option. However, the impulse ventilation option requires the construction of fan chambers at each portal; generates high airflow velocities in the immediate vicinity of the nozzle; and may require more complex control systems, e.g. variable speed fans with inverter drives.

Jetfans are generally installed at high level within a tunnel, outside the traffic envelope. Typical locations for jetfan installation are the tunnel soffit; within tunnel niches constructed specifically for the accommodation of the jetfans; and within the corners between the tunnel walls and soffit. Installation of jetfans at high level provides physical clearance for the movement of vehicles and pedestrians below, and also allows the high velocity air jets from the jetfans (typically 30 to 40 m/s) to decay to acceptable levels (around 10 m/s) before they enter into the occupied zone.

In order to generate the maximum potential thrust, the jet of air issuing from a jetfan should be allowed to decay for a significant distance downstream, before encountering a portal or another jetfan—typically, a spacing of around ten hydraulic tunnel diameters is recommended. Since the majority of jetfan installations require bidirectional operation of the ventilation system, jetfans are not normally installed in the vicinity of tunnel portals. Instead, they are installed deep within tunnels, which drives up the cost of cabling.

The thrust generated by the air issuing from a jetfan to the tunnel air can be described through the following momentum exchange equation:

T=\dot{m}(Vⱼ−V_{T})ηⱼ cos(θ) (Equation 2)

where
T=Thrust imparted from the jet to the tunnel air [Newtons]
\dot{m}=Mass flow of air jet [kilograms per second]
Vⱼ=Velocity of air jet [metres per second]
V_{T}=Velocity of tunnel air [metres per second]
ηⱼ=Installation efficiency [dimensionless]
θ=Angle between the jet and the tunnel axis [radians]

In selecting the most appropriate angle between the jet and the tunnel longitudinal axis, a number of issues should be considered. Depending on the distance between the jetfan and the tunnel surfaces (including the walls and soffit), a shallow angle below about 3 degrees may create a low pressure zone between the jet and a tunnel surface, and thereby cause the jet to adhere to that surface—a phenomenon termed the ‘Coanda effect’.

V. V. Baturin in ‘Fundamentals of Industrial Ventilation’ (1972, Pergamon, Oxford, United Kingdom) reported a range of spread angles of 25° to 27° for free jets issuing from convergent nozzles, and 29° for free jets issuing from cylindrical tubes. The decay of centreline air velocity can be estimated from a correlation proposed by Baturin, which is based on a review of experimental data. However, for jets that attach to a surface (Coanda effect), I. M. C. Farquharson in his paper ‘The ventilating air jet’ (1952, JIHVE, 19, 449-69) found that the centreline velocity for an attached jet can be up to 40% higher that that of a free jet, due to the restricted entrainment of air into the attached jet.

The Coanda effect causes additional frictional drag, and hence a reduction in the effective thrust generated by the jet. Air jets that are angled towards the centreline of a tunnel can be detached from the bounding tunnel surfaces, and hence a larger thrust can be generated. However, this benefit should be balanced against the larger air velocities that may be generated in the occupied zone, and which may lead to dangerous conditions for pedestrians and high-sided vehicles (such as heavy-goods vehicles).

Whether a jet remains free or attaches itself to a tunnel surface at different angles to the tunnel axis depends on the ratio of the jet's momentum force in a direction normal to the surface, to the pressure force acting to push the jet, towards the surface. For jets issuing parallel to the tunnel axis, it is likely that attachment to a nearby surface (soffit, wall or both) will occur within a few metres of the jet discharge plane.

Computational Fluid Dynamics (CFD) calculations have indicated that a relatively large angle towards the tunnel centreline, such as 7° or greater, may cause the jet to attach to the tunnel floor, and to flow at high speed for some distance downstream. However, the airflow velocity above the jet may be below the critical velocity for smoke control. Under these circumstances, smoke from a fire may actually travel upstream for some distance from a fire source, a phenomenon termed ‘back-layering’. Such back-layering of smoke may represent a danger to any persons present upstream of the fire source.

A previous European patent EP 1050684 described a method of directing the airflow from a jetfan at a range of angles between 3 and 25 degrees, which is claimed to improve the thrust generated by such jetfans. However, the large jet angles proposed may lead to the drawbacks outlined above in terms of attachment of the jet to the tunnel floor, and possible back-layering of any smoke within the tunnel.

Another European patent EP1598604 proposed using a fan mounted on a vertical axis, delivering a jet of air through a side nozzle. However, this method involves turning the airflow within the ventilation device through an angle of 90 degrees or more, with resulting undesirable pressure losses. Such pressure losses may be acceptable for car park applications, but not for tunnels, due to the significantly higher airflows required.

The Applicants believe that there remains scope for improvements to tunnel ventilation systems.

### SUMMARY OF THE INVENTION

According to a first aspect of the present invention, there is provided an apparatus for installation in a tunnel to provide ventilation in the tunnel, comprising a fan assembly comprising:

a fan or fans for generating a ventilating flow; and

a nozzle having a throughbore coupled to the fan or fans such that the longitudinal axis of the nozzle's throughbore is generally parallel to the axis of rotation of the fan or fans;

the assembly being arranged or arrangeable such that a ventilating flow generated by the fan or fans will pass through the nozzle's throughbore before exiting the assembly to enter a tunnel to be ventilated; and

wherein the cross-sectional area of the nozzle's throughbore decreases in the direction away from the fan or fans such that the nozzle will in use act to accelerate the ventilating flow from the fan or fans as it passes from the fan rotor through the nozzle prior to discharge into a tunnel so as to increase the velocity of the ventilating flow from a first velocity imparted to the flow at the fan or fans by the fan or fans to a second higher velocity at the nozzle discharge into the tunnel.

The tunnel ventilation apparatus of the present invention comprises, inter alia, a fan for generating a ventilating flow that may be installed in a tunnel. This is similar to the known use of “jetfans” for ventilating tunnels, as discussed above.

However, the apparatus of the present invention further comprises a nozzle through which the ventilating flow from the fan is directed before the flow exits the fan assembly (and thus enters the tunnel in use).

The nozzle's throughbore and the fan's rotational axis are arranged to be generally parallel (i.e. such that the flow from the fan and the flow through the nozzle in use will be generally parallel). This avoids the flow from the fan having to turn through a significant angle (e.g. 90°) in order to pass through the nozzle (which could result in significant pressure losses).

Moreover, the nozzle is shaped such that its cross-sectional area narrows in the direction away from the fan. The effect of this is that the nozzle's throughbore narrows in the direction of the ventilating flow that the fan may generate in use.

In other words, in the fan assembly of the present invention, the ventilating flow generated by the fan is passed through a convergent nozzle before it exits the assembly (and enters the tunnel).

The effect of this is that the ventilating flow generated by the fan is accelerated by the nozzle and so will provide additional thrust to the tunnel air (or other gases, e.g. smoke or water vapour).

In particular, as discussed above, the effect of the nozzle should be so as to provide at the nozzle's outlet a ventilating flow that has been accelerated (has a higher velocity) as compared to the flow as it leaves the fan or fans (the velocity imparted by the fan or fans themselves).

Thus, the ventilation apparatus of the present invention can provide an enhanced longitudinal thrust within a tunnel. This is achieved by using a convergent nozzle to accelerate the outlet flow from the fan.

This then means that, for example, fewer fan assemblies should be needed for a given tunnel ventilation requirement, thereby reducing costs and other requirements in relation to procurement and installation.

In particular, with reference to Equations 1 and 2 above, the thrust generated by a jetfan is proportional to the jetfan's discharge velocity, and hence an increase in the jet velocity can generate a proportional increase in the thrust, given the same mass flow of air. The Applicants have thus recognised that a convergent nozzle attached within the ductwork downstream of a fan can accelerate the airflow, and hence provide additional thrust to the tunnel air.

The pressure drop across a subsonic nozzle is approximately given by

$$Δ P = \frac{1}{2} ρ {V}_{j}^{2} \qquad ( Equation 3 )$$

where
ΔP=Pressure drop across a nozzle [Pascals]
ρ=Density of air [kilograms per m³]
Vⱼ=Velocity of air jet at the nozzle discharge [metres per second]
The main approximation in Equation 3 relates the neglect of the skin friction drag on the nozzle's internal surfaces, which is usually a reasonable assumption due to the relatively small magnitude of the skin friction.

It follows from Equation 3 that an increase in the jet velocity due to the presence of a convergent nozzle would lead to a larger aerodynamic pressure drop. By way of illustration only, an increase in jet velocity from 30 m/s to 50 m/s would imply an increase in the nozzle pressure drop from 540 Pa to 1500 Pa, assuming an air density of 1.2 kg/m³. The increase in jet velocity would cause the thrust delivered by such a nozzle to increase by 67%, assuming that the mass flowrate through the fan is unchanged.

As will be appreciated from the above, there will be an additional pressure drop across the convergent nozzle in the apparatus of the present invention. This may lead to increased power consumption by the fan, since the power consumed is proportional to the product of pressure drop and volumetric flowrate.

However, the Applicants have recognised that this is an acceptable feature of this invention, since the present invention should, in effect, allow a smaller number of higher-powered fans, rather than the large numbers of lower-powered fans currently being used in tunnels, to be used.

By using a convergent nozzle to turn the exhaust flow from a fan towards the tunnel centreline, a significant improvement in the proportion of aerodynamic thrust imparted to the tunnel air, as opposed to being wasted on friction along the tunnel surfaces, can be obtained. Another way of expressing this physical phenomenon is to state that the invention can be arranged such that less power is required per unit of thrust, compared to a conventional jetfan design.

Thus, depending on the particular aspects of this invention that are selected, the overall power consumption requirement with this invention may in fact be similar or less than to that of a conventional jetfan design. Moreover, the smaller number of fans that should be required when using the present invention will allow significant benefits in terms of reduced fan procurement, installation, cabling, and/or civil engineering costs for the construction of jetfan niches.

The present invention also extends to the use of the apparatus of the present invention to ventilate a tunnel, and to tunnel ventilation systems that include the apparatus of the present invention.

Thus according to a second aspect of the present invention, there is provided a method of ventilating a tunnel, comprising:

generating a ventilating flow along the length of the tunnel using a fan or fans installed in the tunnel;

passing the ventilating flow from the fan or fans through the throughbore of a nozzle that is coupled to the fan or fans and mounted generally parallel with the fan or fans before the ventilating flow enters the tunnel, the nozzle's throughbore being shaped such that its cross-sectional area decreases in the direction away from the fan or fans, whereby the nozzle will accelerate the ventilating flow from the fan or fans before it enters the tunnel so as to increase the velocity of the ventilating flow from a first velocity imparted to the flow at the fan or fans by the fan or fans to a second higher velocity at the nozzle discharge into the tunnel.

According to a third aspect of the present invention, there is provided a tunnel ventilation system comprising:

one or more fan assemblies installed in a tunnel and arranged to be able to generate a ventilating flow along the tunnel in use;

and wherein at least one of the fan assemblies installed in the tunnel comprises:

a fan or fans for generating a ventilating flow; and

a nozzle having a throughbore coupled to the fan or fans such that the longitudinal axis of the nozzle's throughbore is generally parallel to the axis of rotation of the fan or fans;

the fan assembly being arranged or arrangeable such that a ventilating flow generated by the fan or fans will pass through the nozzle's throughbore before exiting the assembly to enter a tunnel to be ventilated; and

wherein the cross-sectional area of the nozzle's throughbore decreases in the direction away from the fan or fans such that the nozzle will in use act to accelerate the ventilating flow from the fan or fans as it passes from the fan rotor through the nozzle prior to discharge into a tunnel so as to increase the velocity of the ventilating flow from a first velocity imparted to the flow at the fan or fans by the fan or fans to a second higher velocity at the nozzle discharge into the tunnel.

The fan that is used in the apparatus, method and system of the present invention can be any suitable such fan, i.e. a fan that is suitable for generating a ventilating flow along a tunnel.

The ventilating flow will, as is known in the art, typically and preferably comprise an airflow. However, the invention is applicable where other forms of gaseous ventilating flow are to be generated, for example, mixtures of air, smoke, water vapour and steam.

The size and power of the fan may, e.g., vary, depending upon the size and nature of the tunnel to be ventilated, but for typical tunnels (road, rail, metro, mine), suitable fan parameters would be an internal diameter from 0.5 m to 2 m and a volumetric flow rate through the fan of 5 m³/s to 100 m³/s. The length of a fan assembly, including silencers, flow straighteners and transition pieces, may be measured as a multiple of the fan diameter. A typical length of fan assembly may be in the range of one to ten fan diameters.

The fan will typically comprise, as is known in the art, a fan rotor mounted on a longitudinally extending axle or fan centrebody, and have, e.g., a suitable housing surrounding and mounting the fan rotor and centrebody.

The fan may comprise a single fan rotor, or a plurality of fan rotors mounted in series (on the same axle or fan centrebody), as desired, for example, depending on the required ventilating flow.

It would also be possible for the fan assembly to comprise plural fans, e.g. arranged in series to supply a ventilating flow to a common nozzle, or arranged in parallel to supply a ventilating flow to a single nozzle (e.g. such that plural fans are coupled to a common convergent nozzle, e.g. via a common outlet plenum that supplies the nozzle). This may be desirable where increased ventilating flows are desired, or where a degree of redundancy in the fan provision is required.

It would also be possible, e.g., to provide plural fan assemblies, e.g. each with their own nozzle, either in series or in parallel (or both), if desired.

In a preferred embodiment, each fan is configured so as to match or take account of the presence of the nozzle(s), for example, and preferably, to match the selected fan(s) to the nozzle, in order to achieve the required aerodynamic goals, including delivery of the necessary thrust, when operating in combination with the nozzle.

For example, the additional pressure drop due to the presence of a convergent nozzle may cause the operating point of the fan to change, to deliver less mass-flow at a higher pressure. In a preferred embodiment, the fan is, or the fans are, configured to take account of this (to try to overcome this tendency), i.e. to increase the mass-flow that will be delivered in use. For example, the profile of the fan rotor blades, the blade pitch angles, the fan speed, and/or the number of fan rotors in series, may be, and preferably are selected and/or varied to increase the mass-flow that will be delivered in use.

The nozzle that is coupled to the fan (or fans) in the apparatus of the present invention should, as discussed above, have a throughbore whose cross-sectional area decreases in the direction away from the fan (or fans), so as to “converge” the ventilating flow through the nozzle in that direction and thereby accelerate the gas flow from the fan(s). So long as this requirement is met, the nozzle may be configured as desired.

In other words, there should be at least a section or portion of the nozzle's throughbore along which the cross-sectional area of the throughbore converges, i.e. decreases from a larger cross-sectional area to a smaller (and preferably a minimum) cross-sectional area. The larger part of this convergent section of the nozzle's throughbore should be mounted closer to the fan or fans, i.e. such that there will be a section along the nozzle's throughbore that has a larger cross-sectional area at a point closer to the fan or fans and along which the cross-sectional area of the throughbore decreases in the direction away from the fan or fans (in the direction of the ventilating flow from the fan (or fans)) to a point in the nozzle's throughbore that has a smaller cross-sectional area (and preferably the minimum cross-sectional area of the nozzle's throughbore) (and a cross-sectional area that is less than the (total) cross-sectional area of the ductwork at the fan rotor(s)).

As discussed above, the effect of the nozzle should be so as to accelerate the flow from the fan or fans. The nozzle should therefore converge to a cross-sectional area that is less than the total cross-sectional area of the fan ductwork at the fan rotor or rotors. The nozzle will then have the effect of accelerating the flow from the fan or fans. Where plural fans are coupled to a single nozzle, the nozzle should accordingly converge to a cross-sectional area that is less than the sum of the cross-sectional areas of the ductwork at the fan rotor of all fans that are coupled into the nozzle.

It will be appreciated that the present invention accordingly also extends to the use and provision of nozzle and fan arrangements of this form.

Thus, according to a further aspect of the present invention, there is provided an apparatus for installation in a tunnel to provide ventilation in the tunnel, comprising a fan assembly comprising:

a fan or fans for generating a ventilating flow and surrounded by fan ductwork; and

a nozzle having a throughbore coupled to the fan or fans such that the longitudinal axis of the nozzle's throughbore is generally parallel to the axis of rotation of the fan or fans;

the assembly being arranged or arrangeable such that a ventilating flow generated by the fan or fans will pass through the nozzle's throughbore before exiting the assembly to enter a tunnel to be ventilated; and

wherein the cross-sectional area of the nozzle's throughbore decreases in the direction away from the fan or fans to a cross-sectional area that is less than the cross-sectional area of the ductwork at the position of the rotor of the fan or of the rotors of the fans where there are plural fans.

It will be appreciated that this arrangement can also be used in the other aspects of the invention described herein. Thus, according to further aspects, the present invention provides methods of ventilating a tunnel, tunnel ventilation systems, etc., in which a nozzle whose throughbore decreases in the direction away from the fan or fans to a cross-sectional area that is less than the cross-sectional area of the ductwork at the position of the rotor of the fan or of the rotors of the fans where there are plural fans is coupled to a fan or fans.

The cross-sectional area of the bore through the nozzle preferably decreases progressively (e.g., and preferably, from the location of the nozzle's connection point to the fan ductwork), preferably in a smooth and monotonic manner, to the location of the throughbore's minimum cross-sectional area. The minimum cross-sectional area of the nozzle's throughbore may be denoted its ‘geometric throat’.

In one preferred embodiment, the position of minimum cross-sectional area of the nozzle is its outlet plane. In this case, the nozzles' throughbore will have a greater cross-sectional area at its inlet than at its outlet and the end of the nozzle's throughbore that is closest to the fan (or fans) will have a greater cross-sectional area than the end of the nozzle's throughbore that is furthest from the fan (or fans).

However, it is not necessary for the point (plane) in the throughbore having the minimum cross-sectional area to lie at the nozzle's outlet and the nozzle's throughbore may be extended from the location of the minimum cross-sectional area in a direction away from the fan, e.g. at a constant throughbore cross-sectional area, or, indeed, may get larger again beyond the point of the minimal cross-sectional area. In this latter case, the nozzle will still serve to accelerate the flow from the fan(s), with the exhaust jet likely to separate away from the nozzle throughbore's inner surface at the locations of any sudden enlargements to the nozzle's throughbore.

The choice of whether or not to extend the geometric throat may depend, for example, on the selection of a number of features of the current invention, including noise control, acoustic treatments and fire suppression (as will be discussed further below).

For example, it may be beneficial, as will be discussed further below, to provide a bellmouth transition (i.e. for the nozzle's throughbore to enlarge) at the outlet of nozzle. Thus, in a particularly preferred embodiment, the nozzle's throughout converges in a direction away from the fan to a point where the throughbore has a minimum cross-sectional area, and then diverges beyond that point.

It should also be noted here that the present invention is intended to encompass, and references to a “nozzle” or “nozzles” of the form of the present invention are intended to encompass, any form of construction that has a throughbore that forms (or that can form) an enclosed pathway for the flow from the fan to the outside environment (tunnel) in use and which throughbore has a convergent portion in which the throughbore decreases in cross-sectional area in a direction along the throughbore. Thus, for example, the present invention encompasses such arrangements that perform other functions as well (either as their primary function or as a secondary function), such as devices having such throughbores that perform noise attenuation (silencing) (e.g. convergent silencers) and/or that are arranged to turn the flow in particular direction.

The contraction ratio, defined as the ratio of the fan cross-sectional area to the point at which the nozzle's throughbore has its minimum cross-sectional area (the fan cross-sectional area is the (total) cross-sectional area of the ductwork at the location of the fan rotor(s)), will preferably be selected such that the fan assembly delivers the optimum longitudinal thrust, while ensuring that the air velocities in the occupied tunnel zones remain within acceptable limits.

It is preferred for the contraction ratio for the tunnel ventilation assemblies of this invention to lie in the range of 1.05 to 5.0. The lower bound of the contraction ratio (1.05) stems from commercial feasibility considerations, wherein only modest additional thrust is obtained from the cost of installing a nozzle. The upper bound of the contraction ratio (5.0) corresponds to a value which, in the Applicants' experience, normally lies at or above the stall line for fans, and hence represents the maximum feasible operating point for this type of application.

In a preferred embodiment, the contraction ratio of the nozzle lies in the range 1.1 to 3.0. A contraction ratio of 1.25 has been found to be particularly preferred for at least some fan configurations.

The cross-sectional shape of the nozzle's throughbore will preferably be designed to minimise aerodynamic losses due to effects such as skin friction, recirculation and stagnating flow. For an assembly containing a single fan (or a set of fans arranged co-axially in series), it is preferable that a nozzle throughbore with a circular cross-section is selected, in order to match the circular cross-section of the fan ductwork. With assembles containing multiple fans discharging into a common rectangular plenum, the nozzle will preferably be designed with a throughbore having a rectangular cross-section.

The cross-section at the nozzle's trailing edge (outlet) may be selected and/or changed, for a number of purposes, including noise control.

In a preferred embodiment, the geometry of the nozzle's throughbore (i.e. of its inner surface) is substantially parallel to the flow direction at the nozzle's entry (inlet) and exit (outlet) planes.

In a preferred embodiment, the nozzle's throughbore is symmetrical about its centreline.

In one preferred embodiment, the centreline of the nozzle's outlet (exhaust) is coincident with the centreline of the nozzle's inlet.

In another preferred embodiment, the centreline of the nozzle's outlet (exhaust) is not coincident with the centre line of the nozzle's inlet. This may be desirable where the fan and nozzle assembly is to be installed in a niche in a tunnel's ceiling, for example.

It is similarly preferred in one embodiment for the central longitudinal axis of the nozzle's outlet to be parallel to the central, longitudinal axis of the nozzle's inlet, and in another embodiment for the central longitudinal axis of the nozzle's outlet to not be parallel to the central longitudinal axis of the nozzle's inlet, but to lie at an angle of up to 15 degrees thereto. This latter arrangement may be desirable where it is desired to, for example, direct the flow from the nozzle towards the centreline of the tunnel, rather than parallel to the longitudinal axis of the tunnel.

The nozzle may be coupled to the fan (or fans) that it is associated with in any desired and suitable fashion. It may, for example, be integrally formed with the fan's housing, or it may, e.g., be a separate component that can be attached to (the housing of) a fan or fans.

As discussed above, the nozzle is coupled to the fan or fans such that the nozzle's throughbore (the flow through the nozzle) is generally parallel to the direction of the ventilating flow from the fan or fans (to the fan's rotational axis). In a preferred embodiment, the angle between the fan's rotational axis and the longitudinal axis of the nozzle's throughbore at the outlet (discharge) of the nozzle (the direction of the flow exiting the nozzle) is within the range of 0° to 15°. In one preferred embodiment, the nozzle is coupled to the fan or fans such that the nozzle's throughbore (the flow through the nozzle) is substantially parallel to the direction of the ventilating flow from the fan or fans (to the fan's rotational axis).

The nozzle should also be and preferably is generally co-axial with the fan or fans (to the fan's, or to at least one of the fan's, rotational axis), although again there may be an angle between the fan's rotational axis and the longitudinal axis of the nozzle's throughbore. It would also be possible for the nozzle's axis to be offset from the fan's axis, although in that case the offset should not take the nozzle's axis outside the cross-sectional area of the fan. In one preferred embodiment of the invention, one edge of the nozzle is co-axial with the edge of the fan ductwork (i.e. the offset of the axes of the nozzle and fan in the radial direction is set to be half the difference between the diameter of the ductwork containing the fan and the width (or diameter) of the nozzle exit). In another preferred embodiment, the nozzle is coupled to the fan or fans such that the longitudinal axis of the nozzle's throughbore is substantially co-axial with the axis of rotation of the fan or of one of the fans where there is more than one fan.

The nozzle and/or its throughbore is preferably shaped so as to enhance the rate of entrainment of surrounding air into the jetstream, and/or so as to shorten the effective length of the jet issuing from the nozzle. This will help to enhance the effective thrust of the fan or fans on the air (or other gas) within the tunnel, and to reduce the length of tunnel that may be exposed to high air velocities. It can also help to reduce the noise generated by the discharge of high-speed air within the tunnel.

In a preferred embodiment, the outlet portion (e.g. geometric throat) of the nozzle is also or instead configured and/or shaped so as to control the vortex structures at the nozzle discharge (the shape and size of the vortices shed at the nozzle's discharge) in order to reduce the aerodynamic noise in use.

For example, the nozzle may be shaped so as to have a scalloped trailing edge, and/or so as to include two or more lobes around its trailing edge. Two or more chevrons or tongues, e.g., that are preferably curved or bent so as to protrude into the tunnel airstream, may also or instead be provided around the trailing edge (outlet or distal edge) of the nozzle, for this purpose.

In a particularly preferred embodiment, the centrebody of the fan (or fans) extends into the nozzle, and most preferably extends to and preferably beyond, the outlet plane of the nozzle. This helps to avoid the noise associated with any sudden expansion from the fan annulus to the nozzle.

Where the fan's centrebody extends to or beyond the nozzle discharge (outlet plane), the outer (circumferential) surface of the fan's centrebody at that point is preferably shaped so as to match or correspond to the internal surface of the nozzle at the nozzle's discharge (outlet), such that a constant radial distance between the inner surface of the nozzle and the outer surface of the fan's centrebody is maintained around the circumference of the fan's centrebody in the outlet plane of the nozzle. This will reduce the noise levels further.

In a preferred embodiment, an acoustic absorbent material is applied on part or all of the internal surface of the nozzle's throughbore, and/or on part or all of the external surface of the fan's centrebody. This will help to reduce noise in use of the apparatus. Any suitable acoustic absorbent material may be used for this purpose, such as an acoustic grade mineral fibre, e.g. with an erosion resistant facing and protected and contained by a perforated steel sheet. In this arrangement, the nozzle can, in effect, be thought of as a convergent “silencer”.

The apparatus (the fan and nozzle assembly) of the present invention is adapted to be installed in a tunnel. It is preferably adapted to be installed to the ceiling or wall, e.g. in a ceiling or wall niche, of a tunnel to be ventilated. In a preferred embodiment, the apparatus includes a support and/or housing, that supports and/or mounts the fan and nozzle, and which can be fixed or installed in a tunnel (to the ceiling or wall of a tunnel) for use of the apparatus in the tunnel.

The discharge angle of the nozzle in the tunnel in use is preferably selected and arranged in order to control the air velocities within the occupied zones of the tunnel.

In one preferred embodiment, the fan and nozzle assembly is installed or is capable of being installed in a tunnel such that the jet stream issuing from the nozzle will blow in a direction that is substantially parallel to the tunnel's longitudinal axis.

This will encourage the Coanda effect at the tunnel ceiling (for a ceiling mounted fan assembly) and thus reduce the risk of high air velocities in the main body of the tunnel (e.g. the tunnel's occupied zone). The additional frictional effects due to the Coanda effect may still be significantly overcome by the increased air jet velocity generated in the present invention.

In another preferred embodiment the fan and nozzle assembly is arranged so as to direct the flow from the nozzle towards the longitudinal centreline of the tunnel. For example, where there is no risk of excessive air velocities in the occupied zone of a tunnel, the ventilating flow may be and preferably is directed towards the centreline of the tunnel.

In this case, the flow should still be substantially along the length of the tunnel, but the flow may be directed at an angle towards the centreline of the tunnel, rather than being directed parallel to the longitudinal axis of the tunnel.

In a preferred such arrangement, the flow from the nozzle is directed towards the centreline of the tunnel at an angle of up to 15 degrees relative to the longitudinal axis of the tunnel.

In these arrangements, the flow may be directed towards the centreline of the tunnel in any suitable and desired manner. For example, the fan and nozzle assembly could be tilted in the appropriate direction.

However, in a preferred embodiment, the fan (or fans) is arranged to blow in a direction substantially parallel to the longitudinal axis of the tunnel and the nozzle is arranged to turn the flow from the fan in the desired direction.

This could be achieved, e.g., by the throughbore of the nozzle being shaped so as to redirect the flow as it travels through the nozzle.

Alternatively, the nozzle could be coupled to the fan (or fans) such that the longitudinal axis of the nozzle's throughbore lies at an appropriate angle to the axis of the fan, for example by including an angled transition piece between the nozzle and the fan, so as to mount the nozzle at an angle to the fan.

In these arrangements the nozzle's throughbore's longitudinal axis at the exit (distal end) plane of the nozzle is preferably at an angle of up to 15° relative to the fan's rotational (longitudinal) axis (where an angle of 0° means that the nozzle's and fan's axes are parallel).

Thus, in one preferred embodiment, the direction of (air) flow through the nozzle is substantially parallel to the (air) flow flowing through the fan (or fans), and in another preferred embodiment, the fan and nozzle are arranged such that the (air) flow exiting the nozzle is turned, preferably by up to 15°, relative to the direction of the (air) flow generated by the fan (or fans).

In a particularly preferred embodiment, the fan assembly of the present invention includes means for allowing the injection of a fire suppression agent, such as water mist, into the ventilating flow downstream of the fan (and upstream of the nozzle's trailing edge (outlet)) (i.e. between the fan and the nozzle's trailing edge). The Applicants have recognised that the apparatus of the present invention can be used to effectively deliver a fire suppression agent in use, as the jet stream produced by the apparatus will act to carry and deliver the agent effectively into the tunnel.

In a particularly preferred such arrangement, the fire suppression agent is injected (into the nozzle's throughbore) at or in the vicinity of (preferably just upstream of) the point of minimum cross-sectional area (e.g. at the nozzle's trailing edge (the outlet of the nozzle) where that has the minimum cross-sectional area). This will inject the agent into the flow where the flow velocities are high, but the corresponding static pressures are low, thereby providing more effective delivery of the fire suppression agent into the jet stream. Preferably the fire suppression agent is injected in the geometric throat of the nozzle. The geometric throat of the nozzle may be extended to allow space for the discharge of a fire suppression agent, if desired.

Any suitable fire suppression agent, such as water mist, can be used. If water mist is selected, hydraulic nozzles can be used to deliver the mist into the ventilation apparatus. Preferably, the hydraulic nozzles will be arranged to discharge the water mist at an angle that is approximately parallel to the airflow, in order to induce the minimum aerodynamic pressure drop.

The means for providing the fire suppression agent can be any desired and suitable such means. For example, a plurality of openings may be arranged around (the circumference of) the nozzle's geometric throat via which the agent may be injected into the (air) flow in use. Similarly, the outside of the nozzle may be provided with supply pipes and appropriate fittings and couplings, etc., to allow it to be connected to a suitable source of fire suppression agent.

The fan and nozzle apparatus of the present invention can be used as desired to ventilate a tunnel.

For example, it may be sufficient to install one fan and nozzle assembly at each end of a tunnel to be ventilated (in the vicinity of each tunnel portal). Thus, in one preferred embodiment, the ventilation system of the present invention comprises two fan arrangements in the form of the apparatus of the present invention (one installed at each portal of the tunnel).

The installation of fans with convergent nozzles in the vicinity of a tunnel portal will be similar to the use of a conventional impulse nozzle at each portal of a tunnel, but with the added advantage that no fan chamber needs to be constructed above the portal. Depending upon the length of tunnel, required cooling or air exchange rates and the assumed fire scenario, installations with portal-based ventilation devices according to this invention may provide adequate tunnel ventilation capacity. The cost of cabling to the fans can be minimised, due to their proximity to a portal.

Where aerodynamic thrust beyond that which can be provided solely by portal-based fan and nozzle assemblies is required, for example because of the length of the tunnel to be ventilated, then additional fan arrangements can be installed within the tunnel to provide additional aerodynamic thrust in use.

Even in this case, the number of fans required, and the cost of cabling, can be significantly reduced compared to the equivalent fan option without convergent nozzles.

In this case, any additional fan assemblies to be provided within the tunnel may be conventional jetfan arrangements (i.e. without the nozzle of the apparatus of the present invention), as there will still be an advantage even if only the “portal”-based devices are in the form of the apparatus of the present invention. However, in a particularly preferred embodiment, any fan assemblies installed within the tunnel are in the form of the apparatus of the present invention.

Thus, in a preferred embodiment, the tunnel ventilation system of the present invention comprises a plurality of nozzle and fan assemblies of the present invention arranged at spaced intervals along a tunnel (and configured for operation together).

In case of a fire scenario immediately below a portal-based ventilation device, there is a possibility that these ventilation devices may be damaged due to the effects of fire. However, it should be possible to blow the smoke out of the tunnel using the ventilation device at the far portal, with the assistance of any jetfans installed within the tunnel. The evacuation of people from the tunnel, and rescue efforts by the emergency services, could be effected via the non-incident portal. Any fire that could damage a portal-based ventilation device is likely to very close to the relevant portal, so the escape distances are likely to be quite short, at least in the initial stages of a fire.

It will be appreciated that where the apparatus of the present invention is to be installed within a tunnel (and away from the portal of a tunnel), then it may be preferred for the fan assembly to be capable of bi-directional flow. Thus, in a preferred embodiment, the fan or fans of the apparatus of the present invention is or are capable of blowing bi-directionally. This may be achieved in any desired and suitable manner.

Where the fan (or fans) of the fan assembly is capable of blowing bi-directionally, then the assembly of the present invention could still only have a single nozzle, in which case for one direction of fan blowing, the flow from the fan will pass through the nozzle, but for the other direction the flow from the fan will not pass through a nozzle.

However, in a particularly preferred embodiment where the fan (or fans) can blow in two (opposite) directions, the assembly includes a nozzle of the form of, and arranged in the manner of, the present invention at each end, i.e. such that for either direction of fan-blowing, the flow from the fan (or fans) will pass through a suitably arranged convergent nozzle before entering the tunnel.

Thus, in a particularly preferred embodiment, the fan assembly of the present invention comprises a fan or fans for generating a ventilating flow, the fan or fans being capable of blowing bi-directionally; and

a first nozzle having a throughbore coupled at one side of the fan or fans such that the longitudinal axis of the nozzle's throughbore is generally parallel to the axis of rotation of the fan or fans; and

a second nozzle having a throughbore coupled at the other side of the fan or fans such that the longitudinal axis of the nozzle's throughbore is generally parallel to the axis of rotation of the fan or fans;

the assembly being arranged or arrangeable such that:

a ventilating flow generated by the fan or fans in one direction will pass through the first nozzle's throughbore before exiting the assembly to enter a tunnel to be ventilated; and such that:

a ventilating flow generated by the fan or fans in the opposite direction will pass through the second nozzle's throughbore before exiting the assembly to enter a tunnel to be ventilated;

wherein the cross-sectional area of each nozzle's throughbore decreases in the direction away from the fan or fans such that the nozzle will in use act to accelerate the ventilating flow from the fan or fans as it passes from the fan rotor through the nozzle prior to discharge into a tunnel so as to increase the velocity of the ventilating flow from a first velocity imparted to the flow at the fan or fans by the fan or fans to a second higher velocity at the nozzle discharge into the tunnel; and/or

wherein the cross-sectional-area of each nozzle's throughbore decreases in the direction away from the fan or fans to a cross-sectional area that is less than the cross-sectional area of the ductwork at the position of the rotor of the fan or of the rotors of the fans where there are plural fans.

It will be appreciated that where the fan (or fans) is capable of blowing bi-directionally, the inlet flow to the fan or fans may, in principle, need to (or would, in principle, need to where the assembly has two nozzles, one for each flow direction) pass through a nozzle before entering the fan or fans. This may restrict the inlet flow to the fan or fans.

Thus, in one particularly preferred embodiment where bi-directional fan(s) are used, the fan or fans and nozzle (or nozzles, where there are plural nozzles) are arranged such that gas (air) may be allowed to flow into the fan or fans (from the outside) without first passing through the nozzle in use (without having to pass through a nozzle coupled to that side of the fan or fans), i.e. the fan (or fans) and nozzle(s) are arranged such that gas (air) flow into the fan (or fans) can bypass any nozzle coupled to that (inlet) side of the fan (or fans).

This may be achieved as desired, but in a preferred such embodiment bypass means, such as dampers, are mounted between the nozzle and the fan (or fans) (or between each nozzle and the fan), that can be operated to allow an inlet flow to the fan (or fans) that bypasses the nozzle, for this purpose. Thus, in a preferred embodiment, the fan assembly preferably includes bypass means, such as dampers, between the fan or fans and the nozzle (or between the fan or fans and each nozzle).

It will be appreciated here that in these arrangements where a nozzle may be bypassed, there may still be some inlet flow that comes through the nozzle, and, indeed, it is not necessary to bypass the nozzle entirely. Rather the bypass arrangement is intended to provide a flow path to the fan inlet(s) that is in addition to the flow path through the nozzle's throughbore. Preferably the sum of the free areas for air intake through the nozzle and of the (open) bypass arrangement is arranged to be no less than the (total) cross-sectional area of the ducting at the location of the fan rotor(s).

In order to reduce the risk of air incorrectly bypassing a nozzle, it is preferred that a mechanical or electronic interlock between the bypass means, e.g. dampers, is provided, such that only the upstream set of bypass means are opened, while the downstream bypass means are always shut. In this context, the terms ‘upstream’ and ‘downstream’ refer to the direction of gas flow within the fan or ventilation assembly.

However, the Applicants have also recognised that the provision of such bypass means may not always be necessary, and it may be the case, for example, in many circumstances, that the nozzle at the “inlet” side (in use), will provide sufficient air intake for there to be no need to provide or use any form of “bypass” arrangement. This may be advantageous, because, for example, it can avoid any extra costs, maintenance, risk of failure, etc., that may be associated with a bypass arrangement.

Thus, in one particularly preferred embodiment where bi-directional fan(s) are used, the fan or fans and nozzle (or nozzles, where there are plural nozzles) are arranged such that (sole) gas (air) inlet to the fan or fans (from the outside) is through (via) the nozzle at that side of the fan or fans, i.e. there is no bypass means to allow gas (air) flow into the fan (or fans) that can bypass the nozzle.

In these arrangements where the sole air intake is through a nozzle at the inlet side of the fan or fans, then it is preferred for each of the nozzle throughbore inner surfaces to lie at an angle of 15 degrees or less to the nozzle axis, as this should help to avoid flow separation within the nozzle when it is acting as the sole air inlet. It is also preferred to provide a bellmouth transition at what will be the distal end of the nozzle relative to the fan(s) in use (i.e. for the nozzle's throughbore to diverge again after its point of minimum cross-sectional area), as this should again help to avoid flow separation at the intake plane when the nozzle is acting as the inlet for the fan(s).

Although the present invention has been described above with particular reference to the provision of a particular form or forms of fan and nozzle assembly, the Applicants have recognised that the principles of the present invention can equally be applied and exploited in respect of already existing tunnel ventilation systems that use suitable jetfan arrangements, by fitting a convergent nozzle of the form envisaged to an existing jetfan in the manner of the present invention, so as to convert the jetfan assembly to a fan assembly of the form of the present invention.

The present invention accordingly extends to such fitting of a convergent nozzle or nozzles to an existing tunnel ventilation fan assembly.

Thus, according to a fourth aspect of the present invention, there is provided a method of modifying a fan assembly comprising a fan or fans arranged for providing a ventilating flow in a tunnel, the method comprising:

coupling a nozzle having a throughbore whose cross-sectional area decreases in one direction along the throughbore such that flow through the nozzle in that direction will be accelerated by the nozzle to the fan or fans;

such that:

the longitudinal axis of the nozzle's throughbore is generally parallel to the axis of rotation of the fan or fans;

the coupled fan and nozzle assembly is arranged or arrangeable such that a ventilating flow generated by the fan or fans will pass through the nozzle's throughbore before exiting the assembly to enter the tunnel to be ventilated; and

such that the cross-sectional area of the nozzle's throughbore decreases in the direction away from the fan or fans such that the nozzle will in use act to accelerate the ventilating flow from the fan or fans as it passes from the fan rotor through the nozzle prior to discharge into a tunnel so as to increase the velocity of the ventilating flow from a first velocity imparted to the flow at the fan or fans by the fan or fans to a second higher velocity at the nozzle discharge into the tunnel.

Thus, according to a fifth aspect of the present invention, there is provided a method of modifying a fan assembly comprising a fan or fans arranged for providing a ventilating flow in a tunnel, the method comprising:

coupling to the fan or fans a nozzle having a throughbore whose cross-sectional area decreases in one direction along the throughbore to a cross-sectional area that is less than the cross-sectional area of the fan ductwork at the position of the rotor of the fan or of the rotors of the fans where there are plural fans, such that flow through the nozzle in that direction will be accelerated by the nozzle;

such that:

the longitudinal axis of the nozzle's throughbore is generally parallel to the axis of rotation of the fan or fans;

the coupled fan and nozzle assembly is arranged or arrangeable such that a ventilating flow generated by the fan or fans will pass through the nozzle's throughbore before, exiting the assembly to enter the tunnel to be ventilated; and

such that the cross-sectional area of the nozzle's throughbore decreases in the direction away from the fan or fans.

As will be appreciated by those skilled in the art, this aspect of the present invention can, and preferably does, include any one or more or all of the preferred and optional features of the invention described herein. Thus, for example, a nozzle may be fitted on each side of the fan or fans. Similarly, the nozzle(s) preferably includes the preferred nozzle features described herein, such as having a scalloped, etc., trailing edge, means for allowing the injection of a fire suppression agent, bypass means, such as dampers, etc.

The present invention similarly, accordingly also extends to a nozzle that may be provided for fitting to a fan assembly for this purpose.

Thus, according to a fifth aspect of the present invention, there is provided a nozzle for fitting to a fan for providing a ventilating flow in a tunnel, the nozzle comprising:

a throughbore whose cross-sectional area decreases in one direction along the throughbore such that flow through the nozzle in that direction will be accelerated by the nozzle.

As will be appreciated by those skilled in the art, this aspect of the present invention can, and preferably does, include any one or more or all of the preferred and optional features of the invention described herein. Thus, for example, the nozzle preferably includes one or more of the preferred nozzle features described herein, such as having a scalloped, etc., trailing edge, and/or means for allowing the injection of a fire suppression agent, etc.

Similarly, it is preferred for each of the nozzle throughbore inner surfaces to lie at an angle of 15 degrees or less to the nozzle axis, as this should help to avoid flow separation with the nozzle if it is to act as the sole air inlet in a bi-directional arrangement. It is also preferred for the nozzle's throughbore to converge to its minimum cross-sectional area and then to diverge again after its point of minimum cross-sectional area, as this should again help to avoid flow separation at the intake plane when the nozzle is acting as an inlet for a fan(s) in a bi-directional arrangement.

For example, a bellmouth transition is preferably provided after the point where the nozzle's throughbore has converged to its minimum cross-sectional area.

The present invention may be used to provide ventilation in any desired and suitable form of tunnel. It is envisaged that the present invention will have particular application in vehicular tunnels, such as road, rail or metro tunnels. It may also be used in other tunnels, e.g., mine, station, or cable tunnels. It should also be appreciated here that references to a “tunnel” herein are intended to encompass all forms of “tunnel” structure, whether fully or partially enclosed, in which the present invention can be applied. Thus references to a tunnel herein also encompass, for example, and unless the context otherwise requires, shafts, adits, galleries and cross-passages (and the present invention may equally be used and applied in such structures, if desired). In a preferred embodiment, the invention is used in a vehicular tunnel.

The fan assemblies of the present invention can be operated in use in any desired and suitable manner (and should include, or be coupled to, in use, suitable control means for this purpose). For example, as is known in the art, the fans may be operated to improve the air quality in a tunnel, or smoke control in the event of a fire in the tunnel, and may be controlled to blow in one or other direction along the tunnel as desired.

To provide bidirectional airflow as is normally required for tunnels, fan assemblies in the vicinity of a portal can be arranged to be directed towards the middle of the tunnel, and, for example, the fan control logic can be arranged to operate only fans at the upstream portal, while the fans at the downstream portal would be deactivated. Mid-tunnel fans can be arranged to blow in the appropriate direction.

### BRIEF DESCRIPTION OF THE DRAWINGS

A number of preferred embodiments of the present invention will now be described by way of example only, and with reference to the accompanying drawings, in which:

FIG. 1 shows a first embodiment of a ventilation apparatus installed in the vicinity of a tunnel portal that is in accordance with the present invention;

FIG. 2 shows a plan arrangement of a bank of three impulse fans, with two fans in operation, in a second embodiment of the invention;

FIG. 3 shows a bidirectional ventilation device, in a third embodiment of the invention;

FIG. 4 shows an embodiment of the invention having a symmetrical nozzle design using elliptical curves;

FIG. 5 shows an embodiment of the invention having an asymmetrical nozzle design using elliptical curves;

FIG. 6 shows an embodiment of a ventilation device installed in a tunnel niche in the vicinity of a portal, with an asymmetrical convergent nozzle;

FIG. 7 shows possible fan assembly arrangements for rectangular-section tunnels, in embodiments of this invention;

FIG. 8 shows possible air intake arrangements for domed tunnels, in the embodiments of this invention;

FIG. 9 shows a lobed-type convergent nozzle without a centrebody;

FIG. 10 shows a lobed-type convergent nozzle end with a shaped centrebody;

FIG. 11 shows a convergent nozzle with trailing edge chevrons;

FIG. 12 shows a convergent nozzle with a supply of a fire suppression agent at the nozzle's geometric throat;

FIG. 13 is a graph illustrating the operating conditions of fan assemblies;

FIG. 14 shows a method of ventilating a tunnel, with two fan assemblies installed in the vicinity of a portal;

FIG. 15 shows an axial-flow bidirectional ventilation device, without a bypass device in front of the fan; and

FIG. 16 shows a bidirectional ventilation device, without a bypass device in front of the fan, and with a prescribed nozzle angle.

FIG. 17 shows a unidirectional ventilation device, with inlet guide vanes;

FIG. 18 shows a bidirectional ventilation device, designed to optimise the exit flow angle while maintaining clearances to the traffic envelope;

FIG. 19 shows an end view of a ventilation device, including a convergent nozzle;

FIG. 20 shows a three-dimensional representation of a bi-directional ventilation device;

FIG. 21 shows a typical variation of installed thrust as a function of nozzle area ratio, for a bidirectional ventilation device;

Like reference numerals are used for like components throughout the Figures.

### DETAILED DESCRIPTION OF EMBODIMENTS OF THE INVENTION

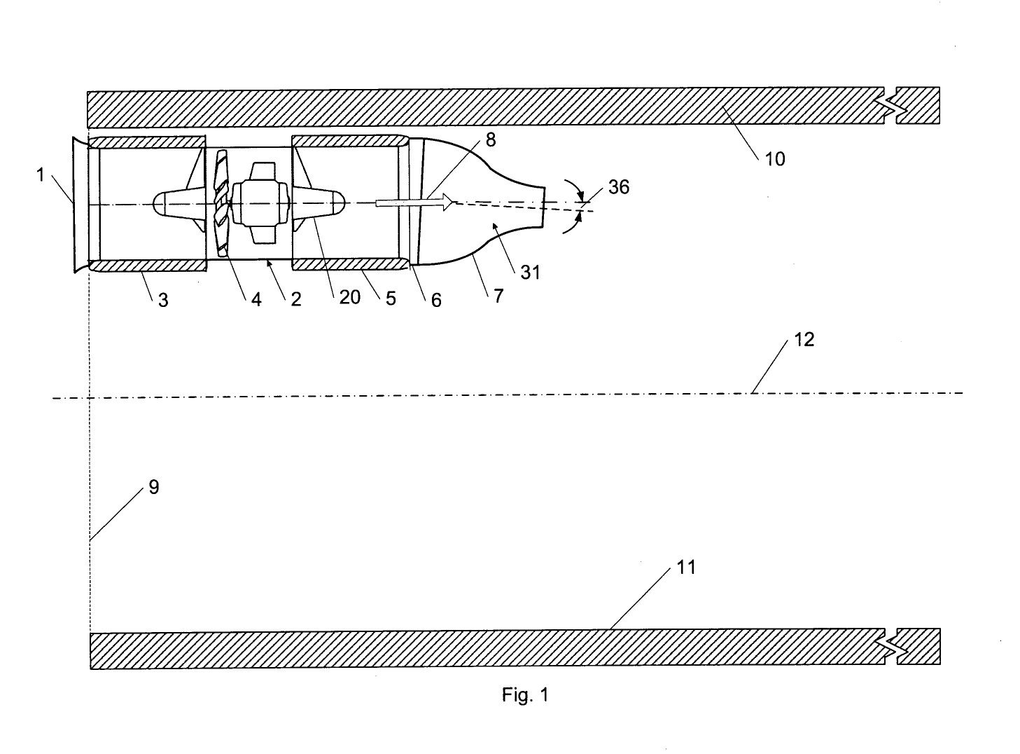

Referring to FIG. 1, this shows a side view of a first embodiment of this invention.

In this embodiment, a fan assembly comprising a fan (2) is installed in the vicinity of a tunnel portal (9). The airflow (8) enters the fan (2) through a bellmouth transition (1) and passes through silencers upstream (3) and downstream (5) of a fan rotor (4) which is supported by a centrebody (20). The airflow is directed through the throughbore (31) of a convergent nozzle (7) (i.e. a nozzle whose throughbore decreases in cross-sectional area, in this case from its inlet to its outlet) which may be directed at a certain angle (36) towards the centreline of the tunnel (12) and away from the tunnel soffit (10) by the installation of an angled transition piece (6). The flow angle is arranged to avoid the attachment of the jet to the tunnel floor (11).

As shown and discussed above, the nozzle converges to a cross-sectional area that is less than the area of the ductwork surrounding the fan rotor at the position of the fan rotor. This means that the nozzle will act to accelerate the flow from its velocity when it “leaves” the fan to a higher velocity when it exits the nozzle.

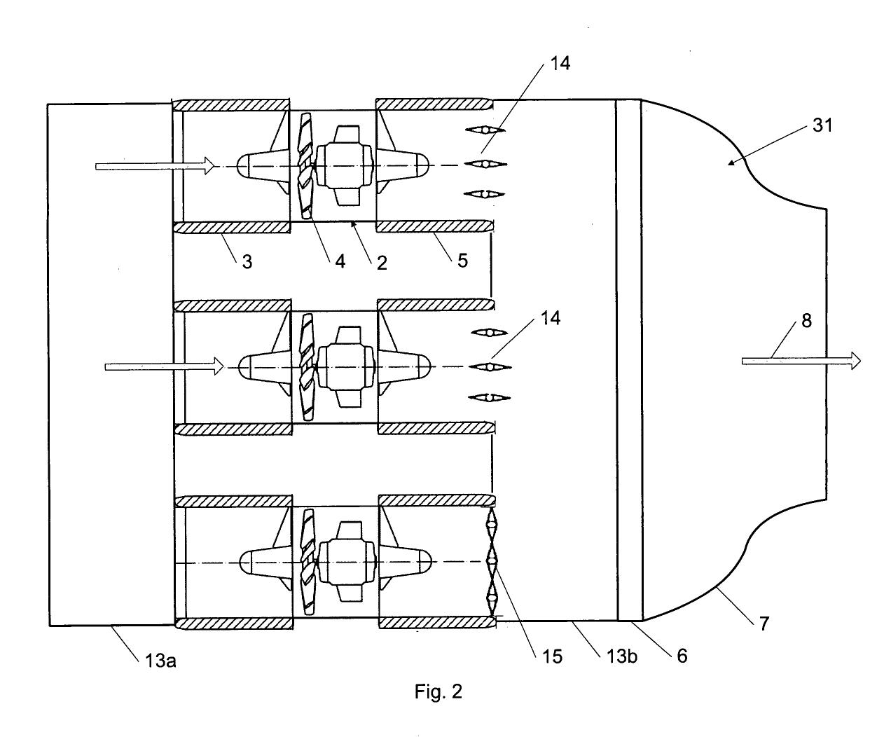

FIG. 2 presents a plan view of the second embodiment of this invention, in which the fan assembly includes a bank of fans. This assembly may again be installed within a tunnel, in the vicinity of a portal. The airflow (8) enters the fans through a common entry plenum (13a), which serves to reduce the overall entry pressure drop to the fan assembly (ventilation device). A number of fans may not be operational due to maintenance, or serve as backup devices only, and are shut off from the airflow path using closed dampers (15). The operational fans drive the flow through open dampers (14) into a common exhaust plenum (13b). The flow is then directed through an angled transition piece (6) and into a convergent nozzle (7). It is also possible to direct the flow from the fans into multiple convergent nozzles.

Again, it should be noted here that the minimum cross-sectional area of the nozzle is less than the combined cross-sectional area of the ductwork at each fan rotor, so that the nozzle will act to accelerate the flow from the fans.

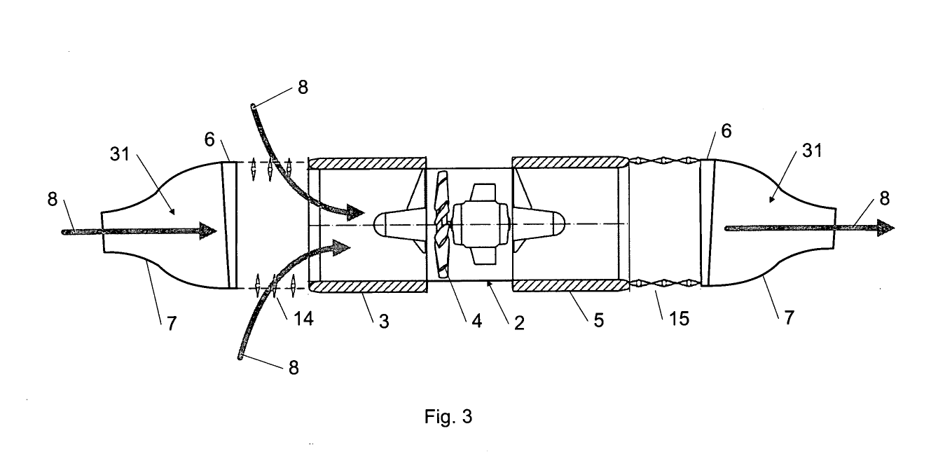

FIG. 3 presents a side view of the third embodiment of this invention, which provides a bidirectional ventilation device that may again be installed in a tunnel. The example provided by FIG. 3 shows the airflow (8) flowing from left to right, but an opposite airflow direction from right to left is also possible through the same fan assembly. A reversible fan rotor (4) draws air through a nozzle (7) and also through open dampers (14) which allow an inlet flow that bypasses the nozzle (7). The sum of the free areas for air intake through the nozzle and the open dampers is preferably arranged to be no less than the cross-sectional area of the ducting at the fan rotor. At the discharge from the fan, closed dampers (15) direct the flow to another convergent nozzle, which discharges the air into the tunnel.

The blades in the open dampers (14) will preferably be arranged to open at certain angles, to minimise the aerodynamic pressure drop across them. Such opening angles will ensure the smooth running of the flow streamlines from the tunnel into the fan assembly.

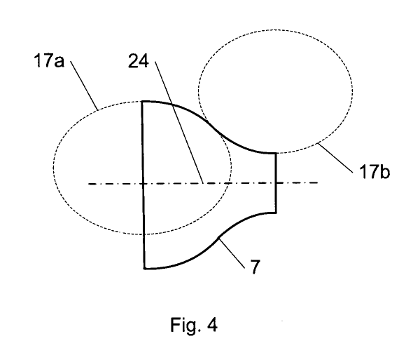

FIG. 4 shows a preferred method of designing a convergent nozzle (7) for use in the fan assembly (ventilation device) of the present invention, using elliptical curves. At entry to the nozzle, ellipse (17a) is drawn with one of its axes aligned with the entry plane of the nozzle. This ensures that the tangent to ellipse (17a) is parallel to the centreline (24) of the nozzle (7), and hence reduces the risk of flow separation, and subsequent aerodynamic pressure drop and noise problems. A second ellipse (17b) is drawn with one of its axes aligned with the exit plane of the nozzle. This ensures that the tangent to ellipse (17b) is parallel to the centreline (24) of the nozzle (7), and the nozzle is therefore likely to produce a uniform flow distribution at its exhaust. At the meeting point between elliptical curves (17a) and (17b), the two elliptical curves are tangential, and hence their gradients are identical. This is an important consideration, to avoid any potential flow separation at the meeting point between the two elliptical curves. In this symmetrical nozzle example, the remaining half of the nozzle is designed to be identical to the first half, mirrored about its centreline (24). It is also possible to approximate the ellipses using circular curves, although the same aerodynamic considerations described here apply.

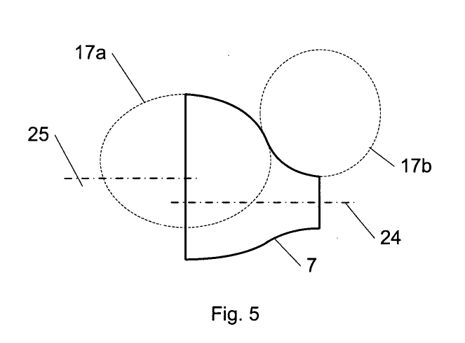

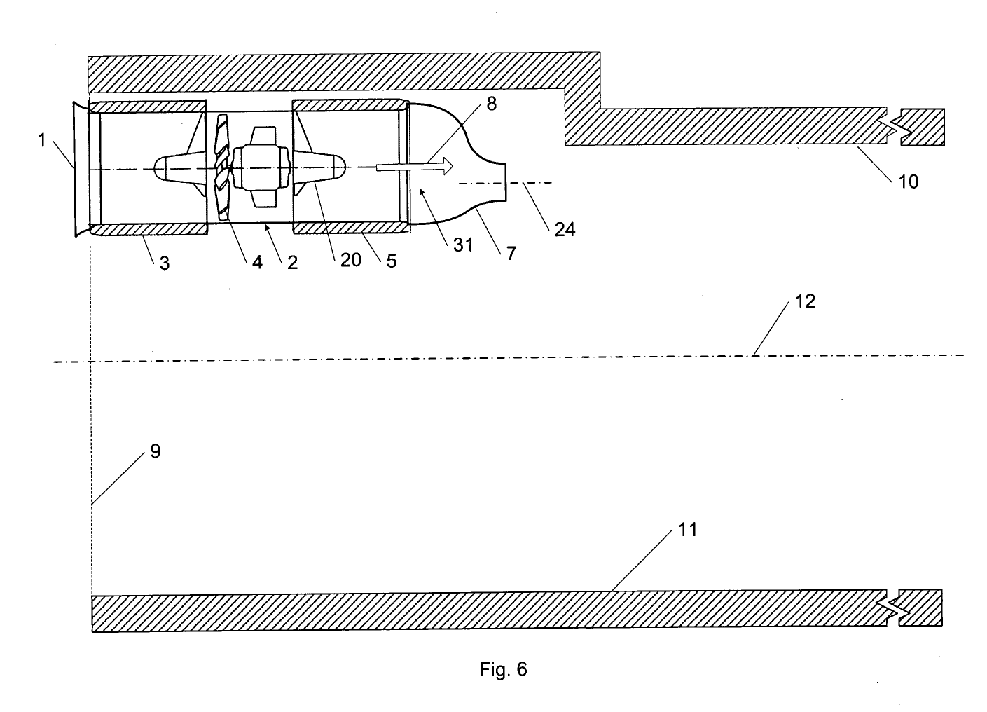

FIG. 5 shows a preferred method of designing an asymmetric convergent nozzle (7) for use in the fan assembly (ventilation device) of the present invention. In an asymmetric convergent nozzle, the centreline (24) of the nozzle exhaust is not coincident with the centreline (25) of the nozzle inlet. Such asymmetric nozzles are most beneficial in cases where the ventilation device is to be installed in a local tunnel enlargement or niche (see FIG. 6), or where a reduction in the Coanda effect is required. Similar to the preferred design of a symmetric nozzle, elliptical curves (17a, 17b) are presented in FIG. 5 to construct the top part of the nozzle, while a different set of two elliptical curves is employed to construct the bottom part of the nozzle. At the entry and exit locations to the nozzle, the elliptical curves are drawn with one of their axes aligned to the said entry and exit locations. At the meeting point between elliptical curves (17a) and (17b), the two elliptical curves are tangential, and hence their gradients are identical. It is again also possible to approximate the ellipses using circular curves.

FIG. 6 shows the installation of a fan assembly comprising a nozzle (7) as shown in FIG. 5 in a tunnel ceiling niche.

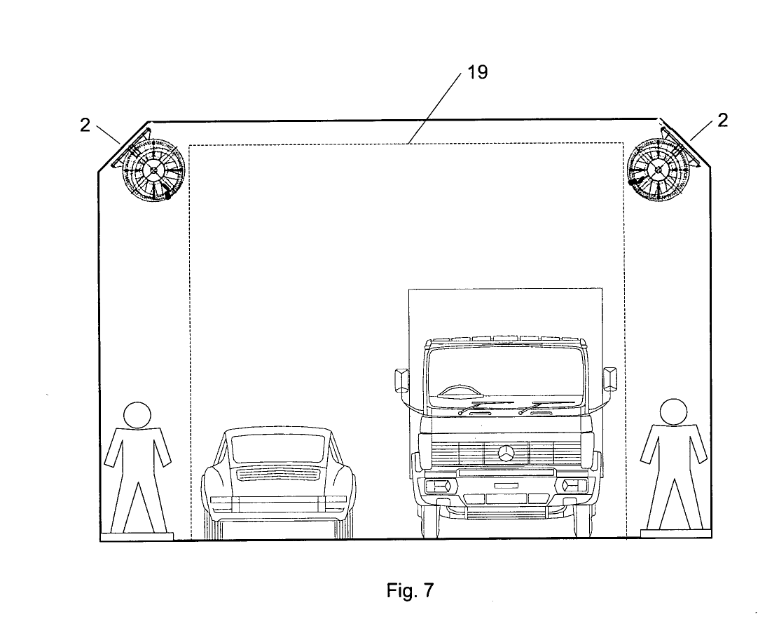

FIG. 7 indicates a preferred arrangement of fan assemblies within a rectangular-section road tunnel. This figure shows that the space required for this invention is no greater than that required for conventional jetfans, but with the significant advantage of a higher aerodynamic thrust being available from the invention.

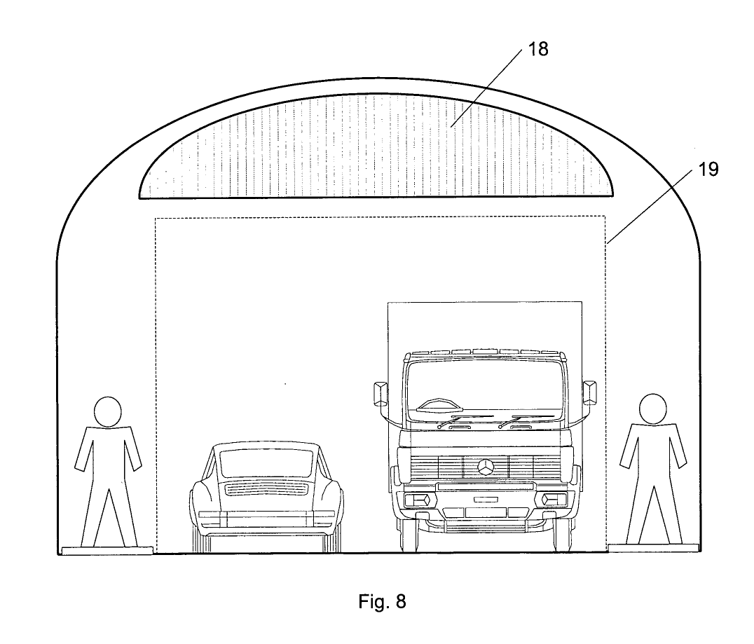

FIG. 8 illustrates the space available for an air intake (18) in the vicinity of a domed road tunnel portal. The air intake is constructed above the tunnel's traffic envelope (19). This large air intake can supply air to a bank of ventilation devices, as indicated in FIG. 2. This arrangement can provide a measure of redundancy in an engineered tunnel ventilation solution, in case of maintenance or damage to one ventilation device. The same air intake arrangements can be applied to rectangular-section tunnels, if space is available.

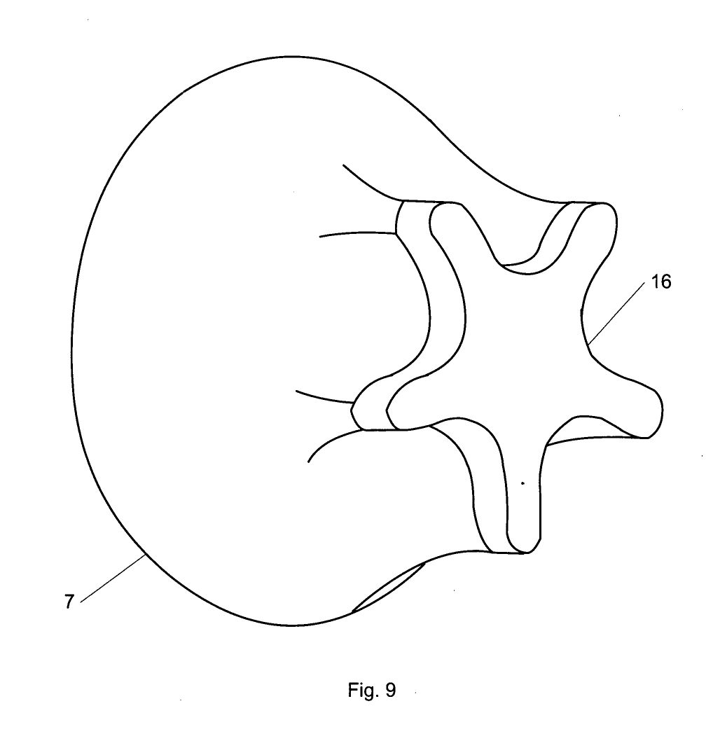

FIG. 9 depicts a convergent nozzle (7) with multiple lobes (16) on its trailing edge, designed to reduce the production of noise, and to shorten the effective length of the air jet downstream of the convergent nozzle. FIG. 9 shows a preferred solution with five lobes, although a nozzle with two or more lobes will also have improved acoustic and jet entrainment properties.

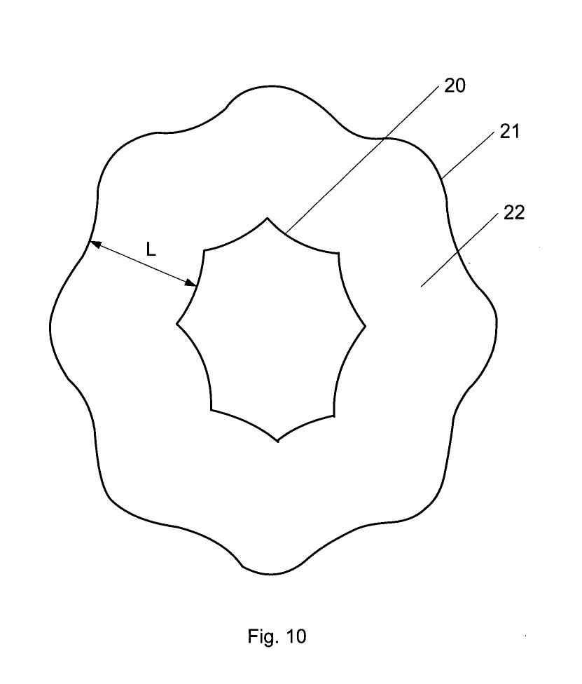

FIG. 10 shows an end view of the trailing edges of a convergent nozzle with a number of lobes, which have the effect of reducing the noise generated by the nozzle, and to increase the rate of entrainment into the jet. The example provided by FIG. 10 shows a nozzle trailing edge (21) with eight lobes, which are reproduced in a shaped fan centrebody (20) with the same number of lobes. In this embodiment, the lobes on the nozzle trailing edge and the fan centrebody are arranged to face each other, such that a broadly constant radial distance L between the fan centrebody and the inner surface of the nozzle (21) is maintained around the circumference of the nozzle exit.

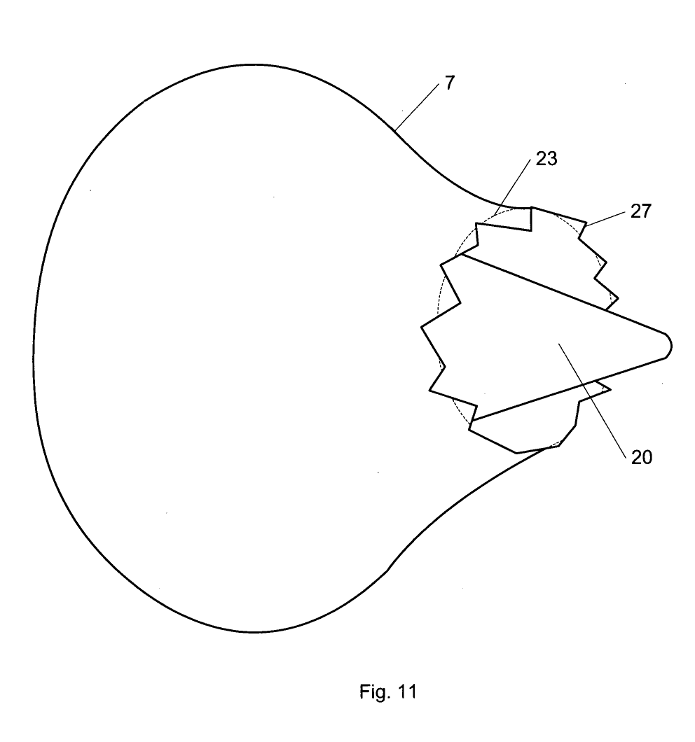

FIG. 11 shows a convergent nozzle (7) with a fan centrebody (20) in which the nozzle trailing edge is shaped with tongues or chevrons (27) that lie around the mean line (23) of the nozzle's trailing edge. The tongues or chevrons can have a variety of shapes, including V-shapes or U-shapes, and can be curved or bent in such a way as to protrude into the tunnel airstream. These protrusions aid the mixing of the tunnel and nozzle airflows, and hence serve to improve the acoustic and aerodynamic performance of the nozzle.

A key purpose of tunnel ventilation is to control the spread of smoke from fires, and the current invention can provide a means of actively suppressing the development of any such tunnel fires.

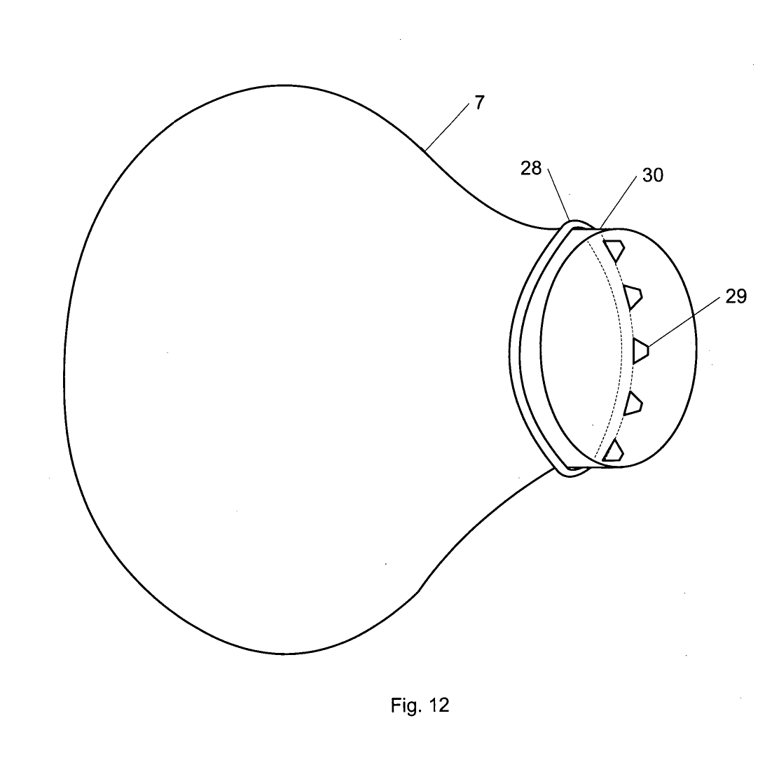

FIG. 12 provides an illustration of an embodiment of this invention that can achieve this.

In this embodiment, the nozzle (7) includes means for injecting a fire suppression agent into the airflow, comprising one or more hydraulic nozzles (29) fed by a supply pipe (28) that is installed within the convergent nozzle (7), for discharging the fire suppression agent into the nozzle in use.

In this embodiment, in the case of a confirmed fire alarm, a fire suppression agent (e.g. water mist) is discharged downstream of the fan, within the nozzle's geometric throat (30), just upstream of the nozzle trailing edge, where the air velocities within the ductwork are high, and the corresponding static pressures are low. The fire suppression agent will be carried by the high air velocities within the nozzle, and is spread along the tunnel through the rapidly expanding jet downstream of the convergent nozzle (7). A complete coverage of the tunnel may therefore be provided from a limited number of ventilation devices.

A range of water-based and gaseous fire suppression agents would be available, and appropriate for consideration. For example, fine water mist particles can be carried a considerable distance downstream of a tunnel, before dropping to the tunnel floor due to the action of gravity, or coalescing into larger water particles.

In a preferred embodiment, acoustic silencing is provided through the provision of absorbent material in the internal surface of the nozzle. The absorbent material is preferably specified as an acoustic grade mineral fibre with an erosion resistant facing, protected and contained by a perforated steel sheet. This can lead to a reduction in the overall length of the ventilation apparatus, since any separate fan silencer (5) can be reduced in length, or even omitted.

If an extended fan centrebody (20) is employed, then additional silencing is possible through the installation of absorbent material on the external surface of the centrebody.

As discussed above, the current invention can be used to enhance the thrust obtained from fans that are already installed in tunnels, by retrofitting a convergent nozzle on one or both sides of a fan.

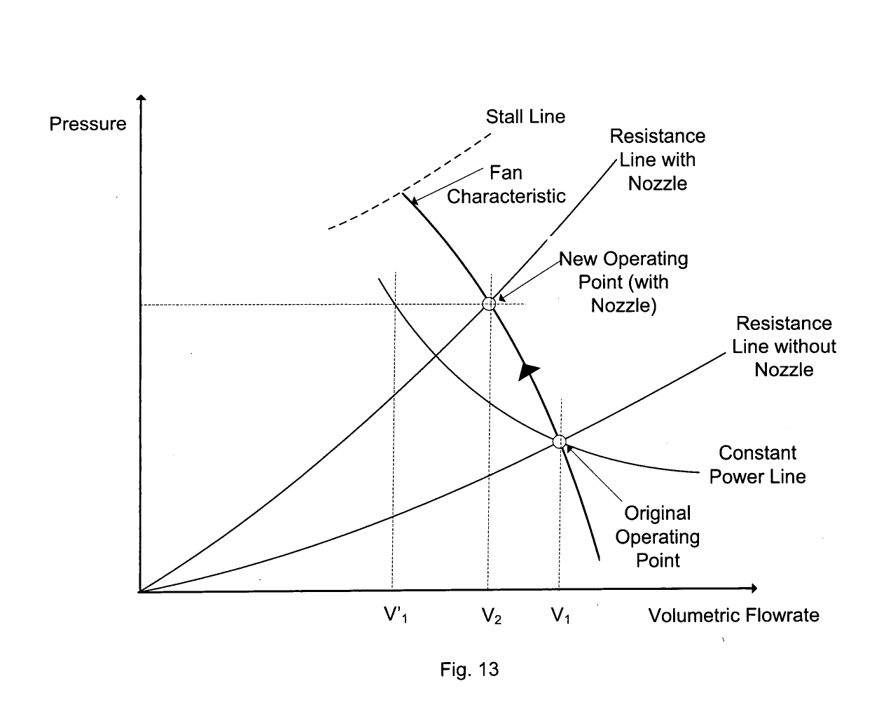

FIG. 13 is a graph showing an exemplary fan characteristic curve (P vs \dot{V}, where P is pressure and \dot{V} is volumetric flowrate) and illustrates the changes in operating points when a nozzle is fitted to a fan. The figure indicates that when a nozzle is fitted to a fan, the volumetric flowrate drops from V₁ to V₂. However, V₂ is still greater than V′₁, where lies on a constant power line from V₁. Hence, as long as the new operating point is below the fan's stall line, it is likely that the installation of a convergent nozzle would lead to an increased thrust produced by the fan. The reason for this is that a fan pressure versus volumetric flowrate characteristic for a given speed and blade configuration is generally steeper than a constant-power relationship between pressure and volumetric flowrate, when the modified operating point is compared to the original operating point. The fan power demand is likely to rise with the installation of a convergent nozzle downstream, and a large proportion of this power will be transferred to the airflow, leading to an increased aerodynamic thrust.

When using a nozzle in the manner of the present invention on the discharge side of the fan or fans then in order to achieve, compared to the thrust generated by a jetfan without nozzles, an enhancement in the thrust of a ventilation device, the fan characteristic (the P vs \dot{V} curve for the fan assembly) of the fan assembly is preferably configured to be ‘steep’ enough to satisfy:

$$- \frac{\partial P}{\partial \dot{V}} > \frac{2 ρ {V}_{j}^{2}}{\dot{V}} \qquad ( Equation 4 )$$

where
\dot{V}=Volumetric flow of air through the ventilation device [m³ per second]
P=Fan static pressure [Pascals]
Vⱼ=Velocity of air jet [metres per second]
ρ=Density of air (the fluid in question) [kilograms per m³]
A number of simplifying assumptions have been made in the derivation of Equation 4 above, including:
The pressure drop through the nozzle is assumed to dominate the overall fan pressure drop;
The jet velocity Vⱼ is assumed to be much greater than the tunnel air velocity V_{T};
The fan characteristic (P-\dot{V} curve) is assumed to be linear within the relevant range.
The skin friction within the nozzle is assumed to be small.

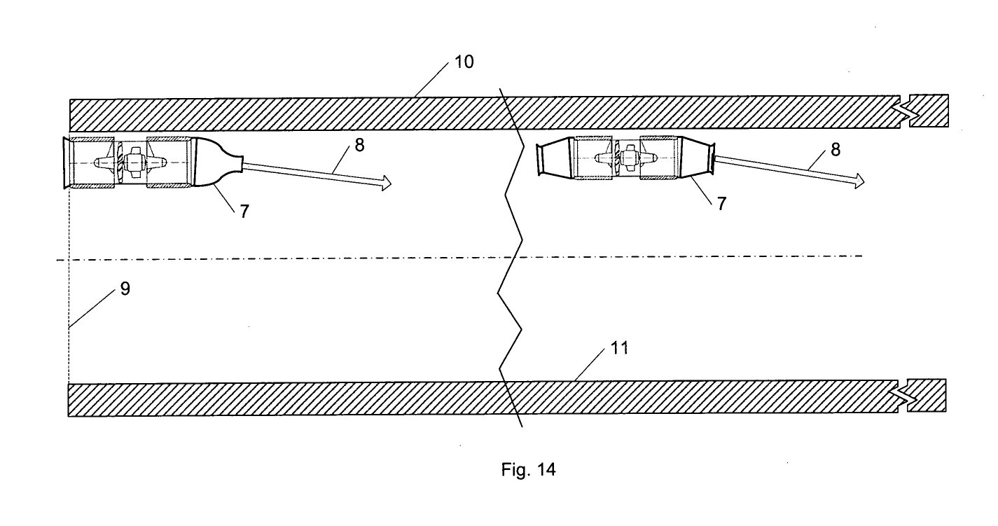

FIG. 14 illustrates how multiple fan assemblies can be arranged in the vicinity of a portal, in order to generate the required longitudinal thrust. Two fan assemblies are depicted in FIG. 14, although any number of fan assemblies can be employed, up to the geometric limits of a particular tunnel. The fan assemblies are configured to drive the airflow towards the far portal. The longitudinal thrust generated on the tunnel airflow is the sum of the individual thrust values provided by each fan assembly. Another set of fan assemblies in the vicinity of the far portal would be required, to provide the facility to drive the airflow in the opposite direction.

In the method illustrated in FIG. 14, one or more fan assemblies at a particular portal may be operational at any instant in time, to generate an aerodynamic thrust in the desired direction. Where a positive pressurisation of the tunnel is required, in order to preclude the entry of smoke from an adjacent tunnel, shaft or cross-passage, fan assemblies at both sets of portals can be operated simultaneously. By switching on an unequal number of fan assemblies at the two portals, it is possible to positively pressurise the tunnel, while still achieving a net longitudinal thrust.

The cabling requirements for tunnel fan assemblies are minimised in the following ways by this invention:
The enhancement of aerodynamic thrust due to the mounting of nozzles means that fewer fans assemblies need to be installed;
The first sets of fan assemblies are normally at the two portals, which are usually the closest points to power supplies;
The invention allows for the air jet at discharge from the fan assembly to be directed downwards towards the tunnel centre-line, and it is therefore less likely that any high-speed air is ingested into a downstream fan assembly. The design rule of providing ten tunnel hydraulic diameters between jetfans can therefore be relaxed with this invention, leading to shorter cable runs;
Since the normal design rules for the longitudinal spacing between fan assemblies can be relaxed, the issue of potential damage to multiple fan assemblies due to a fire becomes more important. However, the minimum distance between fan assemblies to ensure that a fire at one fan assembly does net cause a malfunctioning of a downstream fan assembly can be reduced, by specifying fans that are rated to operate at high temperatures (e.g. 400° C. for two hours).

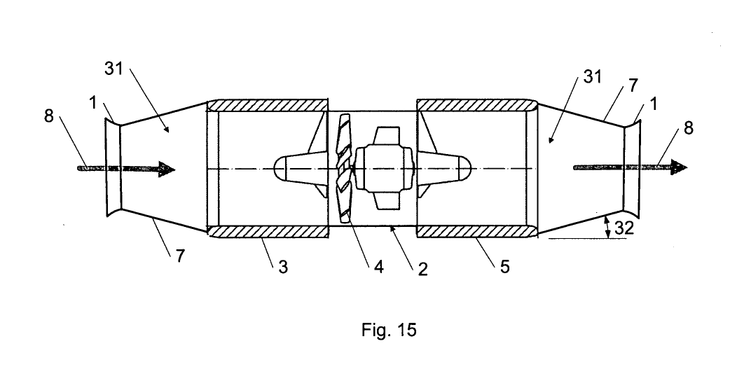

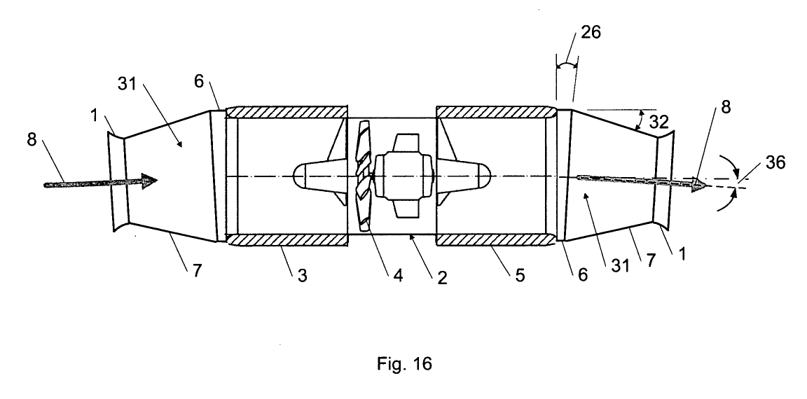

FIGS. 15 and 16 show methods of constructing a bidirectional ventilation device, without the need for any bypass dampers in front of the fan. The examples provided FIGS. 15 and 16 show the airflow (8) flowing from left to right, but an opposite airflow direction from right to left is also possible through the same fan assemblies. The examples provided in FIGS. 15 and 16 show straight nozzle surfaces, with each of the nozzle surface angles (32) arranged to be 15 degrees or less to the fan axis, in order to avoid flow separation within the nozzle on the intake side of the fan assembly. The introduction of bellmouth transitions (1) helps to ensure that there is no flow separation at the intake nozzle inlet. FIG. 15 indicates a ventilation device with a flow direction that is parallel to the fan axis, and FIG. 16 shows angled transition pieces (6) which provide a nozzle angle (26) of up to 15 degrees, in order to reduce the Coanda effect and hence enhance the aerodynamic thrust generated in a tunnel.

There may be significant advantages in not using bypass dampers, due to the lack of any additional moving parts. Such moving parts may present a small risk of not functioning when required, and may require maintenance or replacement within the lifetime of the ventilation device.

Assuming that the inlet and discharge nozzle cross-sectional areas are equal, the additional pressure drop ΔP due to the flow within the intake nozzle in these arrangements can be estimated as:

$$Δ P = \frac{1}{2} {K}_{in} ρ {V}_{j}^{2} \qquad ( Equation 5 )$$

where
Kᵢₙ=Inlet loss flow coefficient (≈0.2 to 0.3)
The pressure drop through the intake nozzle is thus estimated to be about half the value expected through the discharge nozzle (Equation 3).

In view of this additional pressure drop on the intake side, in order to achieve an enhancement in the thrust of a bidirectional ventilation device with nozzles on both sides (and without any bypass dampers) compared to the thrust generated by a jetfan without nozzles, the fan characteristic in this case is preferably configured to be ‘steep’ enough to satisfy

$$- \frac{\partial P}{\partial \dot{V}} > \frac{2 ( 1 + {K}_{i n} ) ρ {V}_{j}^{2}}{\dot{V}} \qquad ( Equation 6 )$$

A number of simplifying assumptions have been made in the derivation of Equation 6 above, including:
The pressure drops through the intake and exhaust nozzles are assumed to dominate the overall fan pressure drop;
The jet velocity Vⱼ is assumed to be much greater than the tunnel air velocity V_{T};
The fan characteristic (P-\dot{V} curve) is assumed to be linear within the relevant range.
The skin friction within the nozzles is assumed to be small.

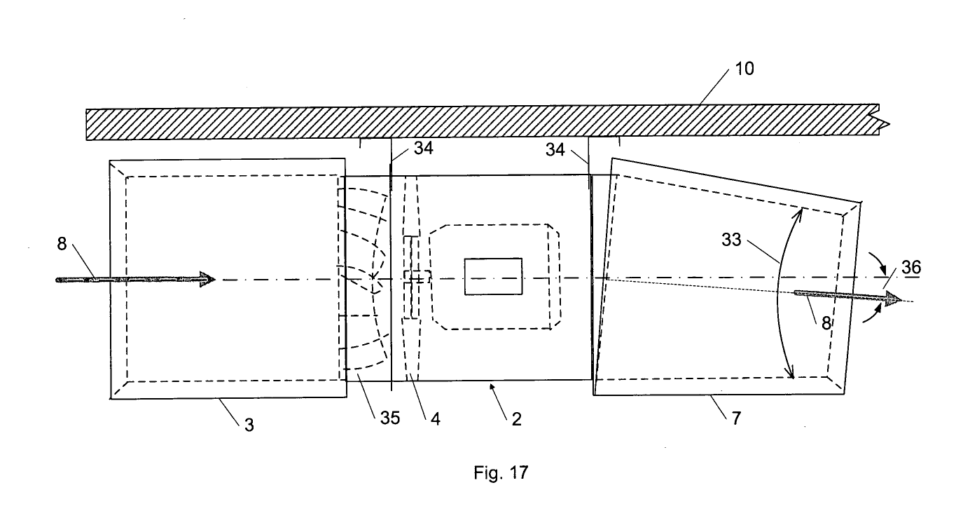

FIG. 17 shows a method of enhancing the thrust of a unidirectional ventilation device, with fluid flowing from left to right. Inlet guide vanes (35) are installed upstream of the fan rotor, in order to align the inlet airflow to the rotor blades. This has the effect of increasing the discharge pressure and the gradient of the fan characteristic (P-\dot{V} curve), both of which serve to enhance the thrust from the ventilation device. Calculations indicate that an improvement in thrust of up to 20% is achievable with this arrangement, compared to the equivalent case without a nozzle.

In addition to the thrust enhancement due to the increase in discharge velocity, a further thrust increase from the ventilation device in use is achieved through the improvement of the installation efficiency, ηⱼ. It is known that if a jetfan is located adjacent to the tunnel wall, ηⱼ=0.85 and for a jetfan in a corner of a rectangular cross-section tunnel, ηⱼ=0.73. By inclining the discharge jet towards the tunnel centreline, values of installation efficiency of nearly unity can be achieved (ηⱼ˜1). The enhancement in thrust due to the increase in installation efficiency is up to 18% for a jetfan located adjacent to a tunnel wall, and up to 37% for a jetfan located in a corner of a rectangular tunnel.

The enhancements in thrust due to discharge velocity increase and those due to increasing the installation efficiency are multiplicative. For example, assuming a 20% increase in thrust due to velocity increase, and for a jetfan located in a corner of a rectangular tunnel, the overall thrust enhancement would be up to (1.20×1.37=1.644), or a 64% thrust increase.

The improvement in thrust provided by the ventilation device in FIG. 17 is obtained without the nozzle impinging upon the traffic space in the tunnel, since the lower part of the ventilation device is kept horizontal. The deflection of the fluid flow downwards is achieved by arranging for the nozzle convergence angle (33) to be approximately twice the flow angle (36).

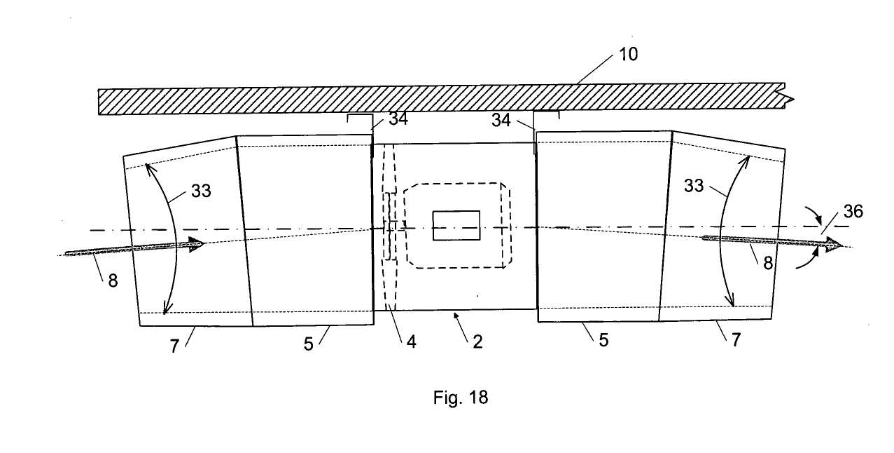

FIG. 18 shows an embodiment of the invention designed to optimise the exit flow angle, while maintaining clearances to the traffic envelope. This allows a significant increase in the installation efficiency for a bidirectional ventilation device, without the installation of any bypass devices (e.g. dampers), and using conventional reversible rotor blades. Based on the improvement in installation efficiency alone (i.e. without consideration of the acceleration of the flow through the discharge nozzle), thrust enhancements of up to 18% for a jetfan located adjacent to a tunnel wall, and up to 37% for a jetfan located in a corner of a rectangular tunnel are available.

A key advantage of this invention is that the improvement in installation efficiency can be obtained with the ventilation device being installed very close to the tunnel soffit and walls, with only the practical consideration of fan mounting (e.g. using anti-vibration mounts) and maintenance access limiting the distance between the fan and the tunnel's solid surfaces. On one application, a reduction in physical clearance from 200 mm to 50 mm was obtained, leading to an overall width reduction of 300 mm in a tunnel, which in turn offered significant reductions in tunnel construction costs.

This invention has several advantages compared with the practice of installing guide vanes at the outlet end of silencers, in order to direct the flow towards the tunnel centreline. One advantage is that the pressure drop associated with a convergent nozzle can be arranged to be significantly less than that which occurs across outlet guide vanes. Another key advantage is that while this invention can be used in a bidirectional mode, there are considerable difficulties in using guide vanes in reverse mode, i.e. when the guide vanes are on the inlet side of the ventilation device, due to the high pressure drops associated with such a flow arrangement. The practise of using a convergent nozzle that is directed towards the tunnel centreline overcomes the problems associated with the use of outlet guide vanes.

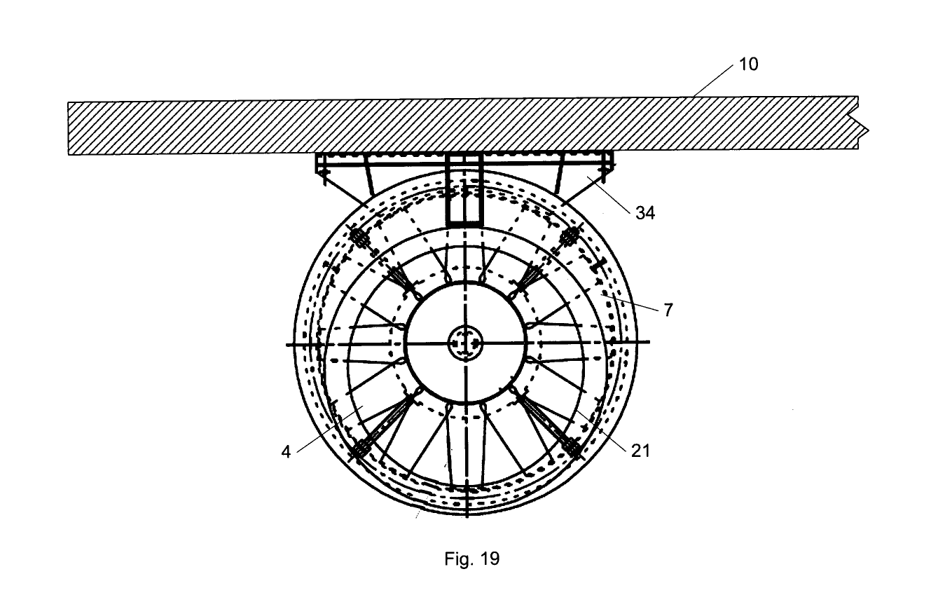

FIG. 19 shows an end view of a ventilation device with the proposed convergent nozzle pointing downwards, i.e. away from the tunnel soffit, in order to minimise the Coanda effect, and hence maximise the installed thrust.

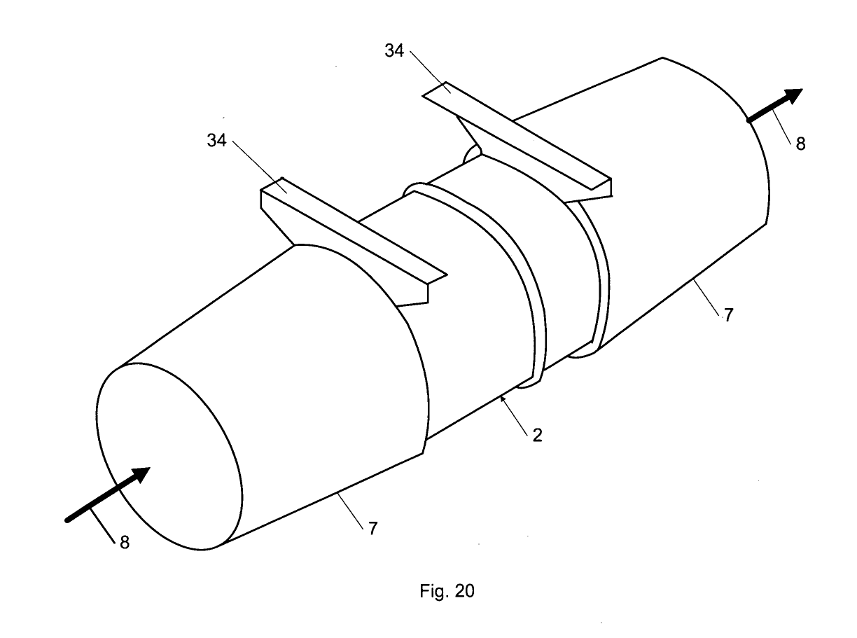

FIG. 20 shows a three-dimensional view of a bi-directional tunnel ventilation device. In this particular embodiment of the invention, the nozzles are arranged in an axial manner, i.e. not directed towards the tunnel centreline. In general however, there are significant aerodynamic advantages in arranging for the nozzles to be directed towards the tunnel centreline.

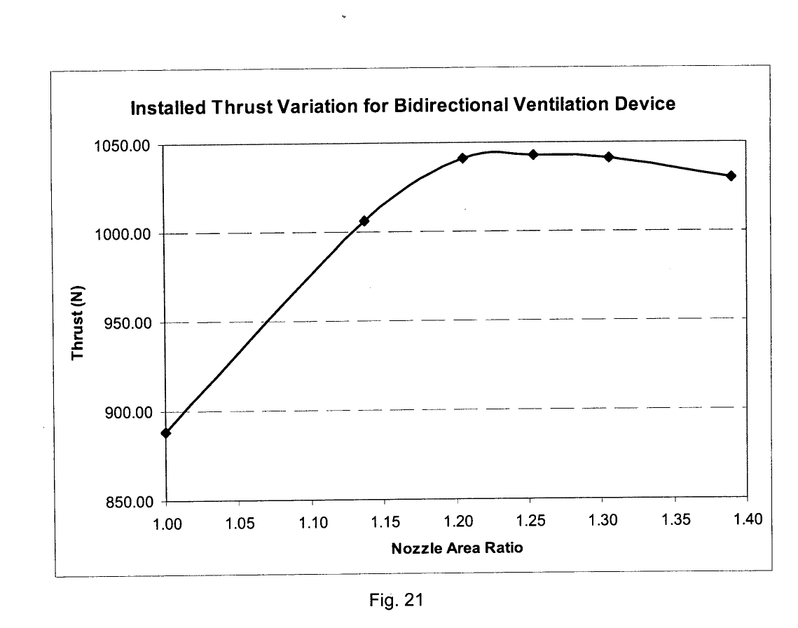

FIG. 21 shows a typical variation of the thrust as a function of nozzle area ratio, for the bidirectional device indicated in FIG. 18 and FIG. 19. The fan in this instance is a 1120 mm fan diameter, truly reversible, 4 Pole, 50 Hz, 1440 rpm, with 36° blade angle. This shows that a peak enhancement in installed thrust of 17% is possible with a nozzle discharge area of 1020 mm, due to an increased installation efficiency and higher discharge air velocity.

### SYMBOLS KEY

1 Bellmouth transition
2 Fan
3 Inlet silencer
4 Fan rotor
5 Silencer
6 Angled transition piece
7 Convergent nozzle
8 Direction of airflow
9 Tunnel portal
10 Tunnel soffit
11 Tunnel floor
12 Tunnel centreline
13a, 13b Plenum
14 Open damper
15 Closed damper
16 Lobe
17a, 17b Elliptical curves
18 Air intake plenum
19 Traffic envelope
20 Fan centrebody
21 Nozzle trailing edge
22 Air path
23 Mean line of nozzle trailing edge
24 Centreline of nozzle exhaust
25 Centreline of fan
26 Nozzle angle
27 Tongue/chevron
28 Supply pipe
29 Water mist nozzle
30 Geometric throat
31 Nozzle throughbore
32 Nozzle surface angle
33 Nozzle convergence angle
34 Supporting bracket
35 Inlet guide vane
36 Flow angle

1. A fan assembly for installation in a tunnel to provide ventilation in the tunnel, the fan assembly comprising:
a fan or fans for generating a ventilating flow; and
a nozzle having a throughbore coupled to the fan or fans such that the longitudinal axis of the nozzle's throughbore is generally parallel to the axis of rotation of the fan or fans;
the assembly being arranged or arrangeable such that a ventilating flow generated by the fan or fans will pass through the nozzle's throughbore before exiting the assembly to enter a tunnel to be ventilated; and
wherein the cross-sectional area of the nozzle's throughbore decreases in the direction away from the fan or fans such that the nozzle will in use act to accelerate a ventilating flow from the fan or fans as it passes from the fan rotor through the nozzle prior to discharge into a tunnel so as to increase the velocity of the ventilating flow from a first velocity imparted to the flow at the fan or fans by the fan or fans to a second higher velocity at the nozzle discharge into the tunnel.

2. The fan assembly of claim 1, wherein the centreline of the outlet of the nozzle is not coincident with the centre line of the inlet of the nozzle.

3. The fan assembly of claim 1, wherein the fan or fans is or are capable of blowing bi-directionally, and the fan assembly further comprises:
a second nozzle having a throughbore coupled at the other side of the fan or fans such that the longitudinal axis of that nozzle's throughbore is generally parallel to the axis of rotation of the fan or fans;
wherein:
the cross-sectional area of the second nozzle's throughbore decreases in the direction away from the fan or fans such that the nozzle will in use act to accelerate a ventilating flow from the fan or fans as it passes from the fan rotor through the nozzle prior to discharge into a tunnel so as to increase the velocity of the ventilating flow from a first velocity imparted to the flow at the fan or fans by the fan or fans to a second higher velocity at the nozzle discharge into the tunnel; and
the assembly is arranged or arrangeable such that:
a ventilating flow generated by the fan or fans in one direction will pass through the first nozzle's throughbore before exiting the assembly to enter a tunnel to be ventilated; and such that:
a ventilating flow generated by the fan or fans in the opposite direction will pass through the second nozzle's throughbore before exiting the assembly to enter a tunnel to be ventilated.

4. The fan assembly of claim 3, wherein bypass means are mounted between each nozzle and the fan or fans to allow an inlet flow to the fan or fans that bypasses the nozzle.

5. The fan assembly of claim 1 wherein the fan assembly includes means for allowing the injection of a fire suppression agent into the ventilating flow downstream of the fan or fans.

6. A tunnel ventilation system comprising:
one or more fan assemblies installed in a tunnel and arranged to be able to generate a ventilating flow along the tunnel in use;
and wherein at least one of the fan assemblies installed in the tunnel comprises a fan assembly comprising:
a fan or fans for generating a ventilating flow; and
a nozzle having a throughbore coupled to the fan or fans such that the longitudinal axis of the nozzle's throughbore is generally parallel to the axis of rotation of the fan or fans;
the assembly being arranged or arrangeable such that a ventilating flow generated by the fan or fans will pass through the nozzle's throughbore before exiting the assembly to enter a tunnel to be ventilated; and
wherein the cross-sectional area of the nozzle's throughbore decreases in the direction away from the fan or fans such that the nozzle will in use act to accelerate a ventilating flow from the fan or fans as it passes from the fan rotor through the nozzle prior to discharge into a tunnel so as to increase the velocity of the ventilating flow from a first velocity imparted to the flow at the fan or fans by the fan or fans to a second higher velocity at the nozzle discharge into the tunnel.

7. The tunnel ventilation system of claim 6 wherein the at least one fan assembly is installed in the tunnel such that the flow from the nozzle is directed towards the centreline of the tunnel at an angle of up to 15 degrees relative to the longitudinal axis of the tunnel.

8. The tunnel ventilation system of claim 6 further comprising two fan assemblies, one of said fan assemblies being installed at each portal of the tunnel.

9. A method of ventilating a tunnel, comprising:
generating a ventilating flow along the length of the tunnel using a fan or fans installed in the tunnel;
passing the ventilating flow from the fan or fans through the throughbore of a nozzle that is coupled to the fan or fans and mounted generally coaxially with the fan or fans before the ventilating flow enters the tunnel, the nozzle's throughbore being shaped such that the cross-sectional area of the nozzle's throughbore decreases in the direction away from the fan or fans such that the nozzle will in use act to accelerate the ventilating flow from the fan or fans as it passes from the fan rotor through the nozzle prior to discharge into the tunnel so as to increase the velocity of the ventilating flow from a first velocity imparted to the flow at the fan or fans by the fan or fans to a second higher velocity at the nozzle discharge into the tunnel.

10. The method of claim 9, comprising injecting a fire suppression agent via the nozzle into the ventilating flow downstream of the fan or fans.

11. The method of claim 9, comprising arranging the fan or fans and nozzle in the tunnel such that the flow from the nozzle is directed towards the centreline of the tunnel at an angle of up to 15 degrees relative to the longitudinal axis of the tunnel.

12. A method of modifying a fan assembly comprising a fan or fans arranged for providing a ventilating flow in a tunnel, the method comprising:
coupling to the fan or fans a nozzle having a throughbore whose cross-sectional area decreases in one direction along the throughbore such that flow from the fan rotor through the nozzle in that direction will be accelerated by the nozzle;
such that:
the longitudinal axis of the nozzle's throughbore is generally parallel to the axis of rotation of the fan or fans;
the coupled fan and nozzle assembly is arranged or arrangeable such that a ventilating flow generated by the fan or fans will pass through the nozzle's throughbore before exiting the assembly to enter the tunnel to be ventilated; and
such that the cross-sectional area of the nozzle's throughbore decreases in the direction away from the fan or fans such that the nozzle will in use act to accelerate the ventilating flow from the fan or fans as it passes from the fan rotor through the nozzle prior to discharge into a tunnel so as to increase the velocity of the ventilating flow from a first velocity imparted to the flow at the fan or fans by the fan or fans to a second higher velocity at the nozzle discharge into the tunnel.

13. The method of claim 12, wherein the nozzle includes means for allowing the injection of a fire suppression agent into the ventilating flow downstream of the fan or fans.

14. The method of claim 12, further comprising coupling a second nozzle having a throughbore having a first end whose cross-sectional area is greater than the cross-sectional area of its other end to the other side of the fan or fans.

15. The method of claim 14, comprising mounting bypass means between each nozzle and the fan or fans to allow an inlet flow to the fan or fans that bypasses the nozzle.

16. A nozzle for fitting to a fan or fans for providing a ventilating flow in a tunnel, the nozzle comprising:
a throughbore having a convergent portion in which the cross-sectional area of the throughbore decreases from one end of the convergent portion to the other, such that flow from the fan rotor through the nozzle in that direction will be accelerated by the nozzle.

17. The nozzle of claim 16, wherein the ratio of the largest cross-sectional area of the nozzle throughbore's convergent portion to the minimum cross-sectional area of the throughbore in the nozzle's convergent portion is in the range of 1.05 to 5.0.

18. The nozzle of claim 16, wherein the centreline of the outlet of the nozzle is not coincident with the centre line of the inlet of the nozzle.

19. The nozzle of claim 16, further comprising means for allowing the injection of a fire suppression agent into the nozzle's throughbore.

20. The nozzle of claim 16, wherein the cross-sectional area of the nozzle's throughbore increases again after the minimum cross-sectional area point of the convergent portion of the nozzle's throughbore.

21-25. (canceled)
